(19) United States
(12) Patent Application Publication
(10) Pub. No.: US 2020/0196535 A1
(43) Pub. Date: Jun. 25, 2020

(54) SYSTEM AND METHOD FOR CONTROLLING A GROWTH ENVIRONMENT OF A CROP

(71) Applicant: 9337-4791 QUEBEC, INC., Montreal (CA)

(72) Inventors: Scott Dickson DAGONDON, Montreal (CA); Ramen Somit DUTTA, Sutton (CA); Alastair MONK, Sutton (CA)

(21) Appl. No.: 16/810,360

(22) Filed: Mar. 5, 2020

Related U.S. Application Data
(63) Continuation of application No. PCT/IB2018/056783, filed on Sep. 5, 2018.
(60) Provisional application No. 62/555,910, filed on Sep. 8, 2017.
(60) Provisional application No. 62/653,480, filed on Apr. 5, 2018.

(51) Int. Cl. A01G 9/18; A01G 7/04; A01G 22/00; G05B 13/02; G06N 20/20; G06N 3/08

(52) U.S. Cl. CPC A01G 9/18; A01G 7/045; G06N 3/08; G05B 13/021; G06N 20/20; A01G 22/00

(57) ABSTRACT

Methods and systems for controlling a growth environment of a crop. The method comprises accessing a set of control data modeling a dynamic growth protocol for the crop; commanding a control device to implement control values; receiving, from a plurality of monitoring devices located within the growth environment, monitoring data relating to the growth environment. The method also comprises calculating a growth index; generating a yield prediction for the crop based on a prediction model; generating a predictive recommendation based on at least the monitoring data, the growth index and the yield prediction; modifying the dynamic growth protocol; and commanding the control device to implement updated control values. A profile for a growth environment of the crop may be selected from a plurality of growth environment profiles obtained from various sources and the selected profile may be updated based on a later growth index.

### CROSS-REFERENCE

The present application claims priority from U.S. Provisional Patent Application No. 62/555,910, filed on Sep. 8, 2017 and from U.S. Provisional Patent Application No. 62/653,480, filed on Apr. 5, 2018, the entirety of both of which being incorporated herein by reference. The present application is a continuation of International Patent Application No. PCT/IB2018/056783, filed on Sep. 5, 2018, the entirety of which being incorporated herein by reference.

### FIELD

The present technology relates to systems and methods of controlling a growth environment of a crop. In particular, the systems and methods allow influencing growth of a crop within a growth environment, such as, but not limited to, a greenhouse.

### BACKGROUND

Controlled growth environments such as greenhouses are typically equipped with control devices and/or monitoring devices (e.g., sensors). The control devices allow controlling environmental factors (equally referred to as environmental conditions or growing conditions) influencing growth of crops within the growth environment. According to known approaches, the environmental factors may be manually altered according to a growth recipe formulated by a master grower and/or an agronomist.

Recent developments have made it possible to automate certain aspects of the control of the control devices based on data collected by monitoring devices. Such recent developments may be found in U.S. Patent Publication 2016/0033943, which teaches sensors providing environmental conditions and plant growth information while control devices regulate the conditions. A calculated data point for a growth of a plant may be generated and an optimum input variable value for the growth may be obtained. A control device setting value may be ascertained based on a target path for achieving a target value.

Other recent developments include technologies described in U.S. Patent Publication 2017/0161560 directed to a system and method for predicting harvest yield. The method includes receiving monitoring data relating to a crop, analyzing via machine vision, multimedia content element, extracting, based on the analysis, features relating to the development of the crop and generating a harvest yield prediction based on the features and a prediction model, which is based on a training input and on a corresponding training output.

Even though the recent developments identified above may provide benefits, improvements are still desirable.

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches.

### SUMMARY

Embodiments of the present technology have been developed based on developers' appreciation of shortcomings associated with the prior art.

In particular, such shortcomings may comprise (1) limited capability of accurately quantifying the development of a physiological characteristic of a crop; (2) limited ability to generate predictive recommendations; and/or (3) limited accuracy of predictive recommendations to improve automation of the control of control devices and/or to modify a dynamic growth protocol.

In one aspect, various implementations of the present technology provide a computer-implemented method for generating a yield prediction algorithm to be associated with a controlled growth environment, the method comprising:

accessing a first set of data associated with the controlled growth environment, the first set of data comprising sensor data and corresponding actual yield values, the sensor data being associated with a plurality of environment parameters;

accessing a database comprising a plurality of features modeling an impact of the plurality of environment parameters and corresponding values of the environment parameters on a growth of a crop;

accessing a plurality of machine learning algorithms (MLAs), the plurality of MLAs having been trained to predict a value of a yield based on at least some of the plurality of environment parameters;

(i) selecting one or more environment parameters amongst the plurality of environment parameters of the database;

(ii) selecting one MLA amongst the plurality of MLAs;

(iii) testing the selected one or more environment parameters on the selected MLA, the testing comprising:
inputting, to the selected MLA, data from the first set of data corresponding to the selected one or more environment parameters;
generating a metric associated with a yield value prediction outputted by the selected MLA, the metric being based on the outputted yield value prediction and the actual yield value corresponding to the data;

selecting a combination of one or more environment parameters and MLA based on metrics generated after a plurality of iterations of (i) to (iii); and

returning the selected combination of one or more environment parameters and MLA.

In other aspects, various implementations of the present technology provide a computer-implemented method for generating a prediction algorithm to be associated with a controlled growth environment, the method comprising:

accessing a first set of data associated with the controlled growth environment;

accessing a database comprising a plurality of features modeling an impact of the plurality of environment parameters and corresponding values of the environment parameters on a growth of a crop;

accessing a plurality of machine learning algorithms (MLAs), the plurality of MLAs having been trained to predict a crop performance based on at least some of the plurality of environment parameters;

selecting a combination of one or more environment parameters and MLA based on metrics generated after a plurality of iterations of testing selected environment parameters and selected MLAs; and

returning the selected combination of one or more environment parameters and MLA.

In a further aspect, various implementations of the present technology provide a computer implemented system, the system comprising:

a processor;

a non-transitory computer-readable medium, the non-transitory computer-readable medium comprising control logic which, upon execution by the processor, causes:
accessing a first set of data associated with a controlled growth environment, the first set of data comprising sensor data and corresponding actual yield values, the sensor data being associated with a plurality of environment parameters;
accessing a database comprising a plurality of features modeling an impact of the plurality of environment parameters and corresponding values of the environment parameters on a growth of a crop;
accessing a plurality of machine learning algorithms (MLAs), the plurality of MLAs having been trained to predict a value of a yield based on at least some of the plurality of environment parameters;
(i) selecting one or more environment parameters amongst the plurality of environment parameters of the database;
(ii) selecting one MLA amongst the plurality of MLAs;
(iii) testing the selected one or more environment parameters on the selected MLA, the testing comprising:
   inputting, to the selected MLA, data from the first set of data corresponding to the selected one or more environment parameters;
   generating a metric associated with a yield value prediction outputted by the selected MLA, the metric being based on the outputted yield value prediction and the actual yield value corresponding to the data;
selecting a combination of one or more environment parameters and MLA based on metrics generated after a plurality of iterations of (i) to (iii); and
returning the selected combination of one or more environment parameters and MLA.

In the context of the present specification, unless expressly provided otherwise, a computer system may refer, but is not limited to, an “electronic device”, an “operation system”, a “system”, a “computer-based system”, a “controller unit”, a “monitoring device”, a “control device” and/or any combination thereof appropriate to the relevant task at hand.

In the context of the present specification, unless expressly provided otherwise, the expression “computer-readable medium” and “memory” are intended to include media of any nature and kind whatsoever, non-limiting examples of which include RAM, ROM, disks (CD-ROMs, DVDs, floppy disks, hard disk drives, etc.), USB keys, flash memory cards, solid state-drives, and tape drives. Still in the context of the present specification, “a” computer-readable medium and “the” computer-readable medium should not be construed as being the same computer-readable medium. To the contrary, and whenever appropriate, “a” computer-readable medium and “the” computer-readable medium may also be construed as a first computer-readable medium and a second computer-readable medium.

In the context of the present specification, unless expressly provided otherwise, the words “first”, “second”, “third”, etc. have been used as adjectives only for the purpose of allowing for distinction between the nouns that they modify from one another, and not for the purpose of describing any particular relationship between those nouns.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a diagram of a computing environment in accordance with an embodiment of the present technology;

FIG. 2 is a diagram of a growth environment in accordance with an embodiment of the present technology;

FIG. 3 is a system that implements a prediction model for monitoring and controlling a growth environment in accordance with an embodiment of the present technology;

FIGS. 4 to 11 are diagrams of various modules executed by the system for monitoring and controlling a growth environment in accordance with an embodiment of the present technology;

FIGS. 12 to 17 are exemplary embodiments of how a growth index may be calculated in accordance with an embodiment of the present technology;

FIG. 18 illustrates examples of generated yield predictions in accordance with an embodiment of the present technology;

FIGS. 19 to 21 are exemplary embodiments of a growth journal in accordance with an embodiment of the present technology;

FIG. 22 is a diagram illustrating a flowchart illustrating a computer-implemented method implementing embodiments of the present technology;

FIGS. 23A and 23B are a diagram illustrating a flowchart illustrating a computer-implemented method implementing other embodiments of the present technology;

FIG. 24 is a graph showing a comparison between a conventional yield prediction, a yield prediction obtained using the present technology, and actual harvest results; and

FIG. 25 illustrates a flow of an algorithm development process in accordance with an embodiment of the present technology.

It should also be noted that, unless otherwise explicitly specified herein, the drawings are not to scale.

### DETAILED DESCRIPTION

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope.

Furthermore, as an aid to understanding, the following description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labeled as a “processor”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. In some embodiments of the present technology, the processor may be a general purpose processor, such as a central processing unit (CPU) or a processor dedicated to a specific purpose, such as a digital signal processor (DSP). Moreover, explicit use of the term a “processor” should not be construed to refer exclusively to hardware capable of executing software, and may implicitly include, without limitation, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown. Moreover, it should be understood that module may include for example, but without being limitative, computer program logic, computer program instructions, software, stack, firmware, hardware circuitry or a combination thereof which provides the required capabilities.

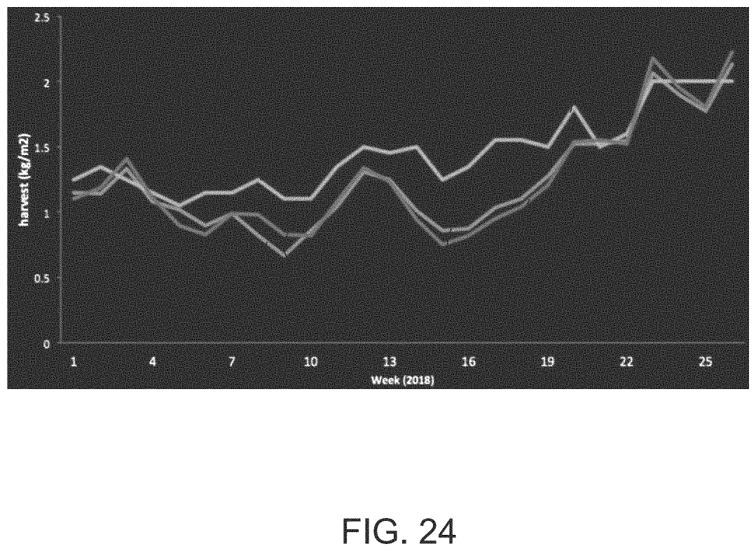

Generally stated, the present technology discloses a prediction model that may be used for designing low-error crop-and-greenhouse-specific yield prediction algorithms. The prediction model may be used to produce, for example, weekly, bi-weekly, monthly, 6-week and/or 8-week harvest forecasts. The prediction model may be applied for use indoor and outdoor climate data, data from sensors deployed at in a greenhouse, plant visual cues, lighting data, and institutional knowledge obtained from the relevant literature. Use of the prediction model for estimating the growth of some crops of interest has provided estimates having lower error rates than when conventional prediction techniques are used. FIG. 24 is a graph showing a comparison between a conventional yield prediction, a yield prediction obtained using the present technology, and actual harvest results. On the graph 2300, a curve 2310 shows actual harvest results over a 25-week period, curves 2320 and 2330 respectively show a conventional yield prediction and a yield prediction obtained using the present technology. An average error of the conventional yield prediction 2320 in view of the actual harvest results 210 is in a range of about 25%. An average error of the yield prediction 2330 obtained using the present technology, in view of the actual harvest results 2310, is in a much lower range of about 6%.

With these fundamentals in place, we will now consider some non-limiting examples to illustrate various implementations of aspects of the present technology.

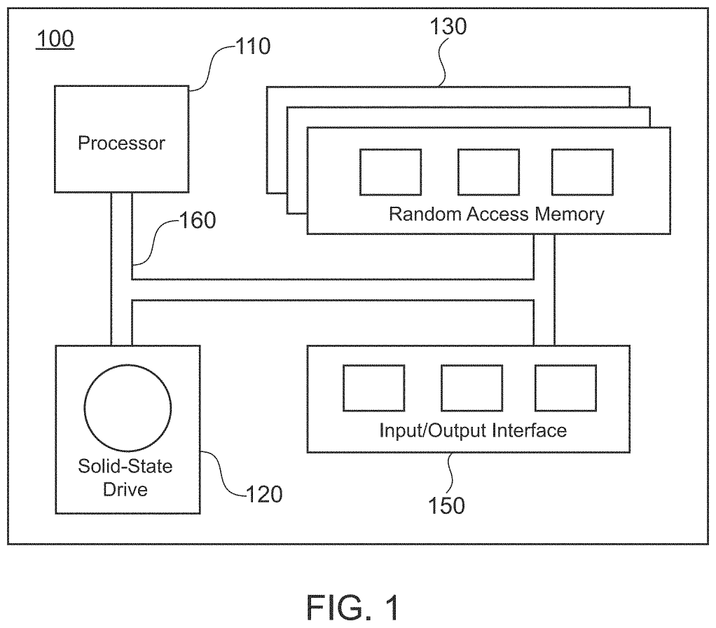

FIG. 1 illustrates a diagram of a computing environment 100 in accordance with an embodiment of the present technology is shown. In some embodiments, the computing environment 100 may be implemented by any of a conventional personal computer, a computer dedicated to operating automated plant cultivation, a controller and/or an electronic device (such as, but not limited to, a mobile device, a tablet device, a server, a controller unit, a control device, a monitoring device etc.) and/or any combination thereof appropriate to the relevant task at hand. In some embodiments, the computing environment 100 comprises various hardware components including one or more single or multi-core processors collectively represented by a processor 110, a solid-state drive 120, a random access memory 130 and an input/output interface 150. The computing environment 100 may be a computer specifically designed for operating automated crop cultivation. In some alternative embodiments, the computing environment 100 may be a generic computer system.

In some embodiments, the computing environment 100 may also be a sub-system of one of the above-listed systems. In some other embodiments, the computing environment 100 may be an “off the shelf” generic computer system. In some embodiments, the computing environment 100 may also be distributed amongst multiple systems. The computing environment 100 may also be specifically dedicated to the implementation of the present technology. As a person in the art of the present technology may appreciate, multiple variations as to how the computing environment 100 is implemented may be envisioned without departing from the scope of the present technology.

Communication between the various components of the computing environment 100 may be enabled by one or more internal and/or external buses 160 (e.g. a PCI bus, universal serial bus, IEEE 1394 “Firewire” bus, SCSI bus, Serial-ATA bus, ARINC bus, etc.), to which the various hardware components are electronically coupled.

The input/output interface 150 may allow enabling networking capabilities such as wire or wireless access. As an example, the input/output interface 150 may comprise a networking interface such as, but not limited to, a network port, a network socket, a network interface controller and the like. Multiple examples of how the networking interface may be implemented will become apparent to the person skilled in the art of the present technology. For example, but without being limitative, the networking interface may implement specific physical layer and data link layer standard such as Ethernet, Fibre Channel, Wi-Fi or Token Ring. The specific physical layer and the data link layer may provide a base for a full network protocol stack, allowing communication among small groups of computers on the same local area network (LAN) and large-scale network communications through routable protocols, such as Internet Protocol (IP).

According to implementations of the present technology, the solid-state drive 120 stores program instructions suitable for being loaded into the random access memory 130 and executed by the processor 110 for executing controlling a growth environment of a crop. For example, the program instructions may be part of a library or an application.

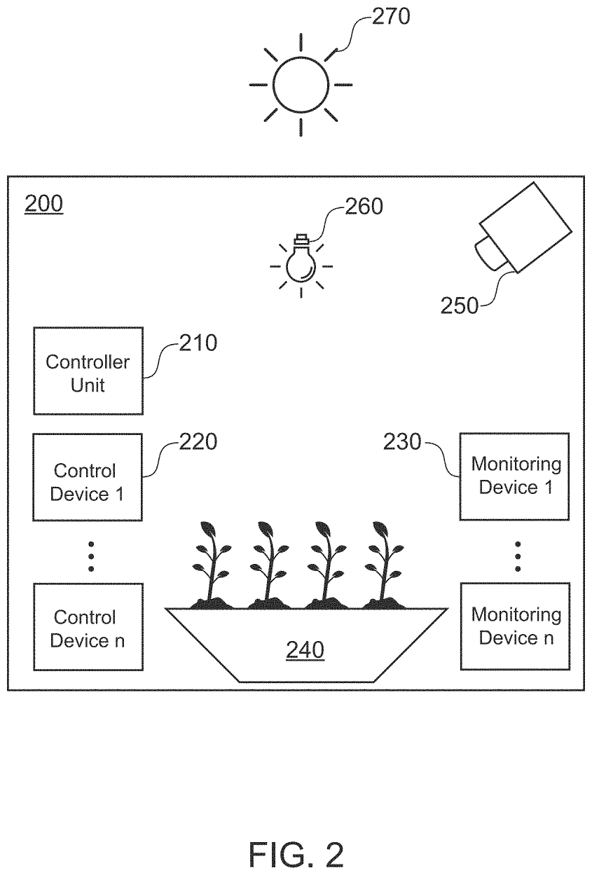

Referring to FIG. 2, a growth environment 200 is depicted. In some embodiments, the growth environment 200 may be a greenhouse such as the ones conventionally used for indoor cultivation. In some embodiments, the growth environment 200 may be referred to as a grow room. In some embodiments, such as for a greenhouse, the growth environment allows a high level of control of at least certain environmental factors. This may be in contrast with outdoor cultivation where less control may be available.

The growth environment 200 comprises a controller unit 210, one or more control devices 220, one or more monitoring devices 230 (also referred to as “sensors”), one or more crops 240, a camera 250 and a light source 260. In some embodiments, the controller unit 210 is connected to the one or more of the control devices 220, the one or more of the monitoring devices 230, the camera 250 and/or the light source 260. The connection may be wired or wireless. In some embodiments, the controller unit 210 may be implemented in a similar way as the computing environment 100 and may comprise control logic to control the one or more of the control devices 220, the one or more of the monitoring devices 230, the camera 250 and/or the light source 260. In some embodiments, the controller unit 210 may receive data from and/or transmit data to the one or more of the control devices 220, the one or more of the monitoring devices 230, the camera 250 and/or the light source 260. In some alternative embodiments, functions of the controller unit 210 may be distributed across the one or more of the control devices 220, the one or more of the monitoring devices 230, the camera 250 and/or the light source 260 thereby resulting in a configuration wherein the one or more of the control devices 220, the one or more of the monitoring devices 230, the camera 250 and/or the light source 260 each comprises control logic. In such embodiment, a controller unit 210 as a standalone unit may not be required.

In some embodiments, the controller unit 210 may have access to a dynamic growth protocol modeled by set of control data and/or monitoring data. As used herein, the expression “dynamic growth protocol” designates a set of instructions to follow in view of obtaining an expected yield for particular crop within a particular environment. The growth protocol is dynamic and adaptable in view of information obtained from time to time, or continuously, from the monitoring devices 230, and processed using machine learning or other artificial intelligence technique. The set of control data and/or monitoring data may be relied upon to control the one or more control devices 220 thereby allowing controlling at least partially a growth environment in which a crop is located. In some embodiments, controlling the growth environment results in influencing directly or indirectly the growth of the one or more crops 240. In some embodiments, the one or more control devices 220 allow mimicking outdoor growing conditions and/or creating specific growing conditions that would have not otherwise been possible outdoor. In some embodiments, the one or more control devices 220 may systematically repeat the dynamic growth protocol thereby allowing systemic cultivation of a crop by controlling an entire cultivation of the crop. As a result, a first yield of the crop may be reproduced in such a way that a second subsequent yield of the crop may be similar to or higher than the first yield of the crop. In some embodiments, the data analytics generated by the growth environment 200 is configured to identify factors that improve yield results and to modify the dynamic growth protocol and thereby improve yield as growth cycles are being executed.

In some embodiments, the one or more control devices 220 allow controlling one or more environmental factors of the growth environment 200. Each one of the one or more control devices 220 may be configured to receive control values which the one or more control devices 220 implement to generate the desired output (e.g., an increase or a decrease of a temperature, an increase or a decrease of a CO2 level, etc.). In some embodiments, the control values are received from the controller unit 210. Non-limiting examples of control devices 220 may comprise, heaters, a Heating, Ventilation and Air-Conditioning (HVAC) unit, pH pumps, nutrient pumps, reservoir heaters, reservoir chillers, solenoid valves, humidifiers, de-humidifiers, air conditioners and/or fans, as well as flow rate, concentration and duration of irrigation equipment used to feed crops. In some embodiments, each one of the one or more control devices 220 may be commanded independently, in accordance with dedicated control values. For example, but without being limitative, control values may comprise a Boolean value (fan_ON, fan_OFF), a numerical value (T=20 Celsius) or other type of values which may become apparent to the person skilled in the art of the present technology.

Even though the embodiment depicted in FIG. 2 illustrates a light source 260 distinct from the one or more control devices 220, it should be understood that the light source 260 may be, in some embodiments, be a control device itself. In some embodiments, the light source 260 may replace the need for a natural light source 270 or used in combination with the natural light source 270.

In some embodiments, the one or more monitoring devices 230 allow sensing one or more environmental factors via a measurement routine of the growth environment 200. In some embodiments, a monitoring device 230 may be an electrical or electro-mechanical device with simple output or may be a more complex computing entity. Each one of the one or more monitoring devices 230 may be configured to generate and transmit monitoring data relating to the growth environment 200. In some embodiments, the monitoring data is transmitted to the controller unit 210. Non-limiting examples of monitoring devices 230 may comprise an air temperature thermometer, a soil temperature thermometer, a liquid temperature thermometer, an Infra-Red (IR) thermometer, an Ultra-Violet (UV) sensor, a Photosynthetically Active Radiation (PAR) level sensor, an Electrical Conductivity (EC) sensor, a Total Dissolved Solid (TDS) sensor, an Oxygen sensor, an atmospheric humidity sensor, a soil moisture sensor, a CO2 sensor, a gas composition sensor, a light level sensor, a color sensor, a pH sensor and/or a liquid level sensor. As a result, the monitoring data may comprise temperature data, atmospheric data, visual data, soil data, etc. Other examples of monitoring devices 230 and/or monitoring data may also be envisioned without departing from the scope of the present technology.

Even though the embodiment depicted in FIG. 2 illustrates a camera 250 distinct from the one or more monitoring devices 230, it should be understood that the camera 250 may be, in some embodiments, be a monitoring device 230 itself. In some embodiments, the camera 250 is an image capturing device generating multimedia files such as, but not limited to, a still camera, a red-green-blue camera, a multi-spectral camera, an hyper-spectral camera, a video camera, etc. In some embodiments, the camera 250 may be configured to capture images and/or videos of at least a portion of the crop 240. The captured images and/or videos (e.g., the multimedia files) may be of various resolutions (low, medium or high resolution). In some embodiments, the resolution is sufficient to allow quantifying a physiological characteristic of the crop (e.g., different stages of a development of the crop 240). In some embodiments, the resolution is High Definition (HD) resolution, such as, 4K resolution so as to provide a sufficient accuracy level of a growth index to be calculated. In some embodiments, the camera is positioned at an angle with respect to the crop. In some embodiments, the angle is 45 degrees. In some other embodiments, the angle is about 45 degrees. In some embodiments, a distance between the camera and the crop is determined so that an entire canopy of the crop may be captured by the camera thereby allowing generation of a growth index of the entire canopy. The captured images and/or videos may also capture wavelengths outside of the visible range of wavelengths (e.g., infra-red wave lengths). The camera 250 may also comprise a communication module allowing transmitting of the captured images and/or videos, for example and without limitation, to the controller unit 210. In some embodiments, the connection between the camera 250 and the controller unit 210 is wired. In some other embodiments, the connection between the camera 250 and the controller unit 210 is wireless. In still further embodiments, the growth index may be calculated based on manual measurements of the physiological characteristic of the crop. Whether based on a multimedia file or on manual measurements, the physiological characteristic of the crop on which the growth index is calculated may include one or more fruit weight, leaf size, stem diameter, number of flower clusters, and number of flowers in clusters.

The crops 240 may include one or more type of crops such as, but not limited to, plants, fruits, vegetables, trees, leaves, etc. In some embodiments, the growing environment 200 is dedicated to a specific type of crops thereby allowing applying a dynamic growth protocol specific to the type of crop. In some other embodiments, the growing environment 200 may control the growth of two distinct crops at a same time (e.g., strawberry and mint). In an exemplary embodiment, the control may rely on a single dynamic growth protocol even though it is used to control the growth of the two distinct crops.

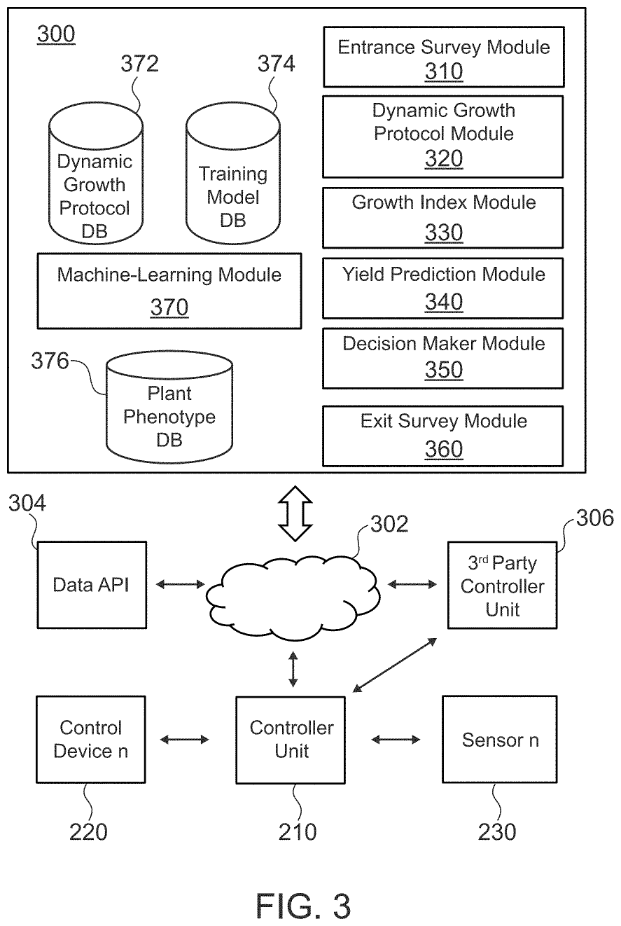

Turning now to FIG. 3, a system 300 that implements a prediction model for monitoring and controlling a growth environment of a crop, such as the growth environment 200, is depicted. In some embodiments, the system 300 is connected to the controller unit 210 and/or the control devices 220 and/or the monitoring devices 230 via a communication channel 302. In some embodiments, the communication channel 302 may be the Internet and/or an Intranet. Multiple embodiments of the communication channel 302 may be envisioned and will become apparent to the person skilled in the art of the present technology. In some embodiments, the system 300 may be connected to the control devices 220 and/or the monitoring devices 230 via the controller unit 210. Other data streams can be envisioned, whereas data from other controller units, distinct from but possibly similar to the system 200. In some embodiment, 3^{rd} party controllers 306 can stream data through an application programming interface (API) in the cloud infrastructure of the communication channel 302, or by using the Controller Unit 210, as a gateway. Other sensor and/or control data can connect directly through the cloud infrastructure, using some kind of network protocol, such as representational state transfer (REST) API 304. In some other embodiments, the system 300 may be directly connected to the control devices 220 and/or the monitoring devices 230. In some alternative embodiments, the system 300 is implemented, at least partially, on the controller device 210. In yet some alternative embodiments, the system 300 may be distributed across the controller unit 210 and/or the control devices 220 and/or the monitoring devices 230.

In some embodiments, the system 300 may be implemented on a computing environment similar to the computing environment 100. In some embodiments, the system 300 may be hosted on a server installed within or in a vicinity of the growth environment 200. In some alternative embodiments, the system 300 may be partially or totally virtualized through a cloud architecture.

In some embodiments, the system 300 comprises an entrance survey module 310, a dynamic growth protocol module 320, a growth index module 330, a yield prediction module 340, a decision maker module 350 and an exit survey module 360. In some embodiments, the system 300 also comprises a machine-learning module 370. The machine-learning module 370 may access a dynamic growth protocol database 372 and/or a training model database 374 and/or a plant phenotype database (DB) 376. The plant phenotype DB 376 contains data that has been categorized by plant phenotype, so that it can be easily accessed by the machine-learning module 370.

In some embodiments, the machine-learning module 370 may implement one or more machine-learning algorithm so as to leverage acquired data with data available in either the dynamic growth protocol database 372 and/or the training model database 374. Examples of machine-learning algorithms implemented by the machine-learning module 370 may comprise, without being limitative, linear regression, logistic regression, decision tree, support vector machine, naïve bayes, K-nearest neighbors, K-means, random forest, dimensionality reduction, neural network, gradient boosting and/or adaboost. In some embodiments, the dynamic growth protocol database 372 and/or a training model database 374 may be implemented through database services such as, without being limitative, MySQL, PoastgreSQL, MongoDB, MariaDB, Microsoft SQL Server, Oracle, Sybase, SAP HANA, MemSQL and/or IBM DB2.

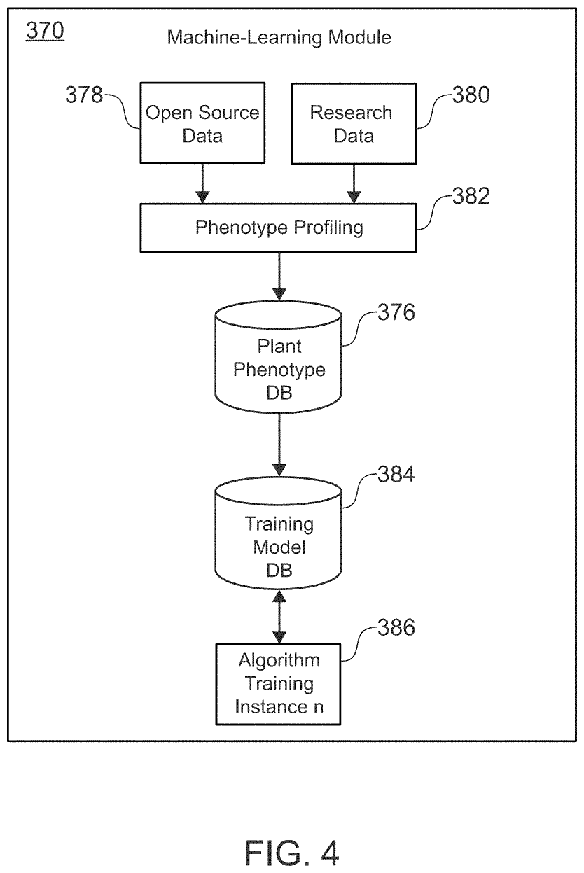

An embodiment of the machine-learning module 310 is exemplified in FIG. 4. In some embodiments, the machine learning module 370 uses data acquired from the plant Phenotype DB 376. Also, data 378 from one or more remote sources such as Open source data models, sources of climate data, and sources of research data 380, obtained from Universities and publications, is continuously fed into the Plant Phenotype DB 376, using a phenotype profiling module 382 to identify the data. In some embodiment, the system 370 may continuously run algorithm training instances 386 in order to improve the efficiency of algorithms according to plant phenotypes from the plant phenotype DB 376. The algorithms scoring may be recorded within a training model DB 384. These algorithms can then be called upon during the execution of the yield prediction API module 700.

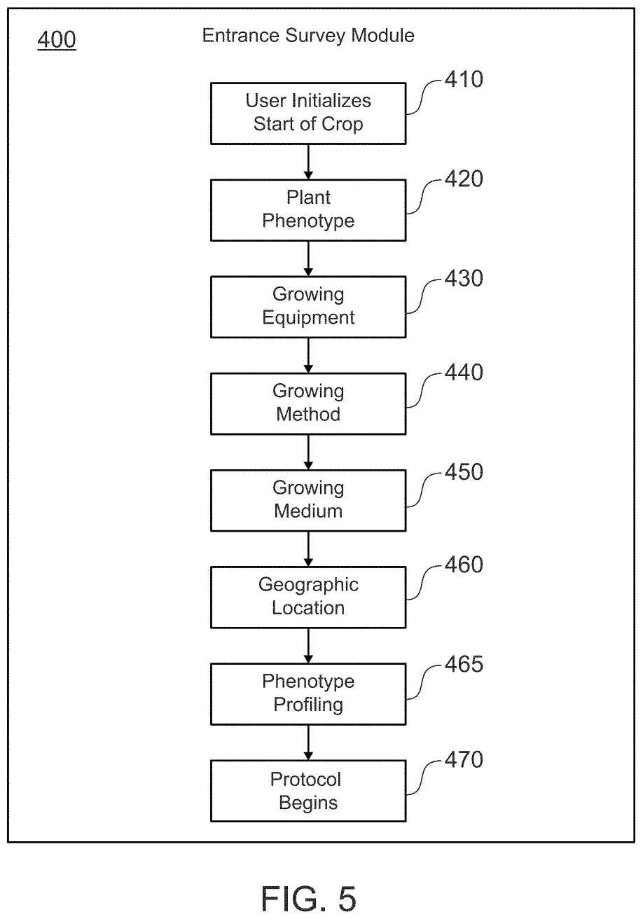

An exemplary embodiment of the entrance survey module 310 is exemplified in FIG. 5. In this embodiment, the entrance survey module 310 is configured to execute various steps of a method 400 allowing collecting data which may then be used by the system 300 to initiate an execution of a growth cycle for a given type of crop. Upon beginning a new growth cycle (e.g., at a time of planting seeds for the given type of crop), the method 400 starts by a step 410 during which a user initializes the start of the cycle. A time stamp identifying the beginning of the cycle may be entered or may be automatically generated. The method 400 may also proceed, at a step 420, with collecting data relating to a plant phenotype. In some embodiments, the plant phenotype may be a set of observable characteristics of a plant resulting from the interaction of its genotype with a given environment. As an example, but without being limitative, the plant Hieracium umbellatum is found growing in two different habitats in Sweden. One habitat is rocky, sea-side cliffs, where the plants are bushy with broad leaves and expanded inflorescences; the other is among sand dunes where the plants grow prostrate with narrow leaves and compact inflorescences. These habitats alternate along the coast of Sweden and the habitat that the seeds of Hieracium umbellatum land in, determine the phenotype that grows. As another example, a first plant phenotype may be a genotype early pink tomatoes grown in supplemental lighting. In yet another example, a second plant phenotype may be inspiration F1 hybrid bell pepper grown in aeroponics using well-water and organic nutrients. At a step 430, the method 400 may proceed with collecting data relating to the growing equipment installed with a growth environment used for the growth cycle. The data may comprise information relating to control devices 220 and/or monitoring devices 230, for example, but without being limitative, the number of control devices 220 and/or monitoring devices 230, the positions of the control devices 220 and/or the monitoring devices 230, specifics relating to the control devices 220 and/or the monitoring devices 230 (e.g., specific time, capability, protocols, settings, etc.). In some embodiments, the data may also comprise information relating to the growth environment itself (e.g., dimensions of the growth environment). At a step 440, the method 400 may proceed with selecting (either automatically or manually) the growing method. As an example, growing methods may comprise, one or more steps, such as (1) foliar feed with nutrients, (2) UV treatment during seeding stage, (3) well-water vs reverse osmosis water used, (4) frequency of reservoir change, (5) nutrients used for plant production and/or additives used for plant production. At a step 450, the method 400 may proceed with selecting (either automatically or manually) the growing medium. As an example, growing medium may comprise one or more of (1) hydroponics or soil, (2) type of soil (e.g., sandy, silty, clay, peaty, saline soil), (3) type of hydroponics (e.g., aeroponics, wick, water culture ebb and flow, Nutrient Film Technique (NFT)), (4) hydroponic growing medium (e.g., rockwool, lightweight expanded clay aggregate also called hydrocorn or grow rock, coconut fiber/coconut chips and/or perlite/vermiculite. In some embodiments, the method 400 may also proceed, at a step 460, with selecting the geographic location of the growth environment as it may, in some instances, have an impact on the growth cycle (e.g., amount of day time, etc.). At step 460, the geographic location is recorded through either location based services, or by user input. In some embodiment, using the data supplied in system 300, plant phenotype is recorded at step 465 into the plant phenotype DB 376 for phenotype profiling purposes. Data stored in the plant phenotype DB 376 can be utilized within the machine learning system 370.

Then the method 400 may proceed, at a step 470, with initiating a dynamic growth protocol. In some embodiments, the dynamic growth protocol associated with the crop may be selected amongst a plurality of dynamic growth protocols stored in the dynamic growth protocol database 372. In some embodiments, the selected dynamic growth protocol may be modified by the system 300 based on the data collected by the entrance survey module 310 executing the method 400. In some embodiments, the modified dynamic growth protocol may then be added to the dynamic growth protocol database 372. In some embodiments, the data collected by the entrance survey module 310 is used by the system 300 to classify the modified dynamic growth protocol, for example, based on the plant phenotype, so that the modified dynamic growth protocol and pre-existing dynamic growth protocols of the dynamic growth protocol database 372 associated with a similar plant phenotype may be leveraged by the machine-learning module 370. In some embodiments, the machine-learning module 370 may aggregate data from the modified dynamic growth protocol and the pre-existing dynamic growth protocols so that multiple dynamic growth protocols from a given user and/or from multiple users may be aggregated to improve a relevancy and/or efficiency of the dynamic growth protocols as the system 300 is used over time.

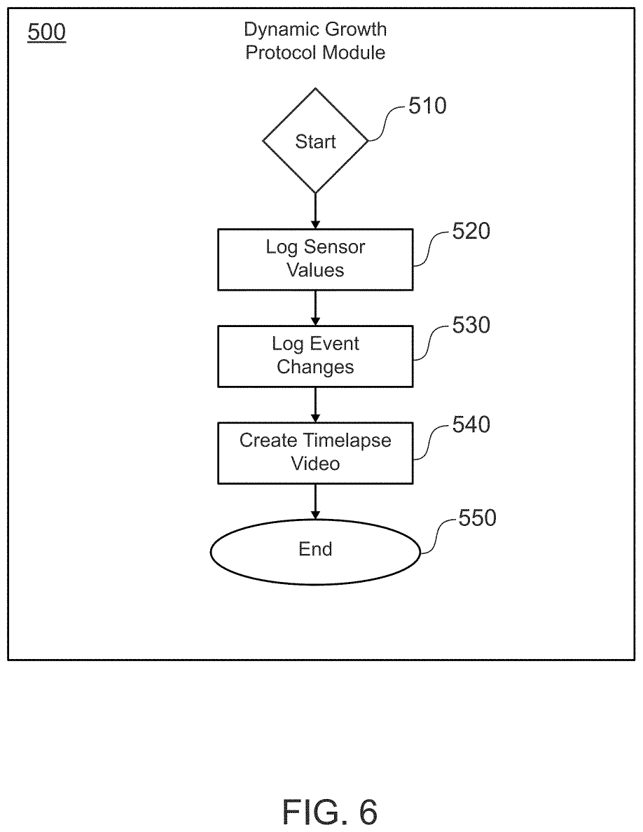

Once the entrance survey module 310 has completed collecting data, the dynamic growth protocol starts being executed by the dynamic growth protocol module 320. An embodiment of the dynamic growth protocol module 320 is exemplified in FIG. 6. In this embodiment, the dynamic growth protocol module 320 is configured to execute various steps of a method 500 allowing execution and/or modification of the dynamic growth protocol. The method 500 starts at 510 by recording an initial state of the crop. In some embodiments, the step 510 may be done manually by the user entering information relating to the initial state or be done automatically by the system 300, for example, based on images and/or videos captured by the camera 250. At a step 520, the method 500 proceeds with acquiring data from monitoring devices 230 located within the growth environment. The acquired data comprises monitoring data relating to the growth environment. For example, but without being limitative, the monitoring data may comprise air temperature, relative humidity, humidify deficit, light level, photosynthetically active radiation (PAR) level, Red/Blue/Green levels, ultraviolet (UV) level, infrared (IR) level, CO2 level, pH level, electrical conductivity (EC) level, total dissolved solids (TDS) level, reservoir temperature, reservoir water level, dissolved oxygen, and the like. In some embodiments, the method 500 also acquires original set points such as alerts associated with the monitoring devices 230 and/or triggers associated with the control devices 220. In some embodiments, the alerts may be alert set points comprising a set of values used to notify a user when a monitoring device 230 has exceeded a given range. As an example, if pH alert set points are set in the range of 5.5-6.5 and the pH drops to 5.0, then an alert may be sent to the user. The alert may consist of a desktop notification, a mobile notification, email, SMS and/or phone call. In some embodiments, the alert set points may automatically adjust to when growing conditions exceed ideal ranges for the dynamic growth protocol. An algorithm may be used to compare data from previous growth journals with similar plant phenotype and adjust the alert set points accordingly. In some embodiments, the triggers may be trigger set points comprising a set of values used to control devices 220 when a monitoring device 230 exceeds a given range. As an example, if a humidifier set point is in the range of 30-50%, then the humidifier may toggle “ON” when humidity device drops below 30% and toggle “OFF” at 50%. Alternatively, if de-humifier set points are set in the range of 80-60%, then the de-humifier may toggle “ON” when humidity device rises to 80% and toggle “OFF” at 60%. The trigger set points may automatically adjust to mimic the best growing conditions within a dynamic growth protocol. An algorithm may be used to compare data from previous growth journals with similar plant phenotypes and adjust trigger set points accordingly.

Next, iterative steps 530 and 540 may be executed. Step 530 ensures recording of event changes detected by the monitoring devices 230 (i.e., a change of temperature at a given time, a change of pH level at a given time, etc.). In some embodiments, step 530 may be conducted manually, for example, via a user entering at least some of the event changes into the system. Step 530 iterates during the whole crop cycle. Step 540 allows capturing images and/or videos at a given frequency (e.g., in continuous or at every given period of time). The method 500 may end at step 550 once an end of a crop cycle is determined either manually or automatically.

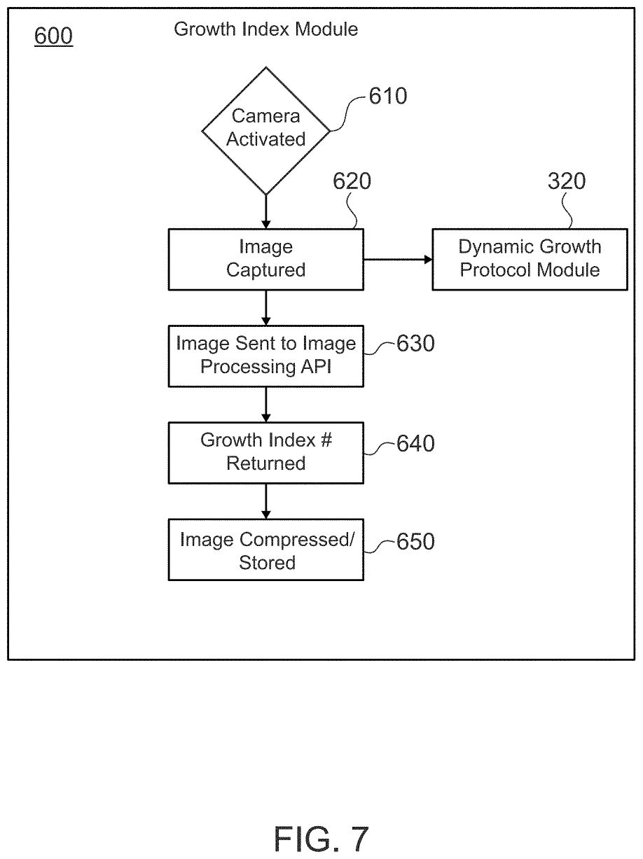

Once the dynamic growth protocol starts being executed by the dynamic growth protocol module 320, the growth index module 330 is activated. An exemplary embodiment of the growth index module 330 is exemplified in FIG. 7. In this embodiment, the growth index module 330 is configured to execute various steps of a method 600 allowing calculating a growth index quantifying a physiological characteristic of the crop. In some embodiments, the growth index may be a numerical value reflective of a photosynthesis activity and/or reflective of a development of the crop. In some embodiments, the physiological characteristic of the crop may be indicative of the size of the crop and/or the health of the crop. In some embodiments, the physiological characteristic of the crop may be indicative of the color of the crop and/or a change of the color of the crop.

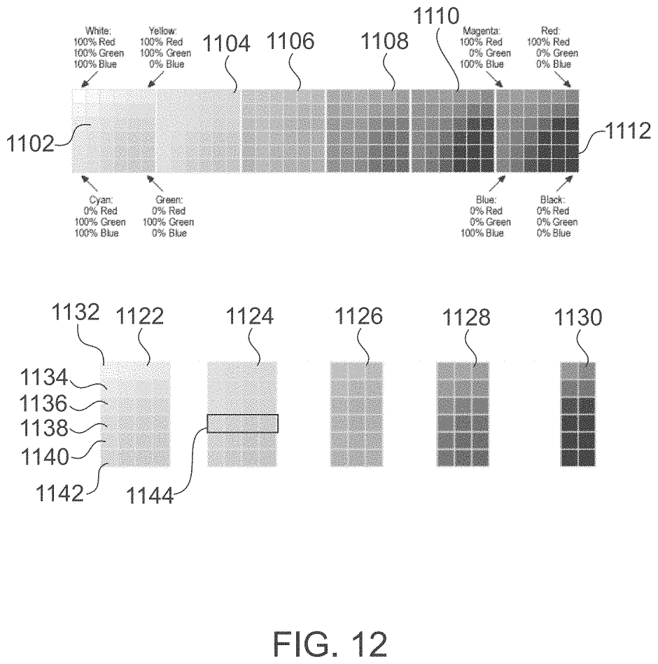

The method 600 starts at step 610 by determining whether a camera is connected to the system, such as the camera 250, is activated. If it is the case, then the method 600 proceeds to step 620 by capturing images and/or video with the camera. In some embodiments, the captured images and/or videos may be transmitted to the dynamic growth protocol module 320. In some embodiments, the captured images and/or videos may be transmitted to a dedicated processing API 630. The dedicated processing API 630 may be hosted by the system 300 or may be hosted by a dedicated service platform accessible by the system 300. The dedicated processing API 630 may comprise logic to be executed so as to generate a growth index based on the captured images and/or videos. Examples of such logic are detailed in connection with the description of FIG. 12. At a step 640, the method 600 returns the growth index which may be stored in and/or transmitted to the dynamic growth protocol module 320. In some embodiments, the method 600, at a step 650, proceeds with compressing and/or storing the captured images and/or videos so that it may later be used, for example to create a time-lapse video creation.

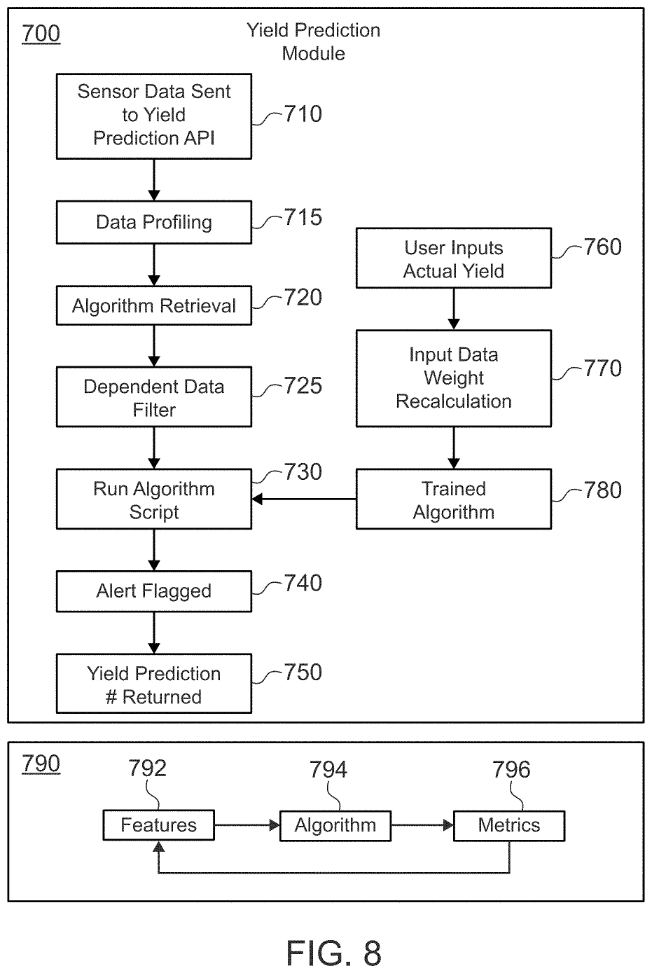

An embodiment of the yield prediction module 340 is exemplified in FIG. 8. In this embodiment, the yield prediction module 340 is configured to execute various steps of a method 700 that uses the prediction model to generate one or more yield predictions for the crop. As monitoring data and/or controlling data is collected by the dynamic growth protocol module 320, the yield prediction module may start generating one or more yield predictions. In some embodiments, the yield prediction module 340 may take the form of a yield prediction API. The yield prediction API may be hosted by the system 300 or may be hosted by a dedicated service platform accessible by the system 300. In some embodiments, the method 700, at a step 710, sends the monitoring data and/or the controlling data to the yield prediction API. At step 715, data is profiled and compared to contents of the training model DB 384 to find adequate algorithms for yield prediction that would give results with the least error possible. Then at step 720, the algorithm is retrieved from the training model DB 384. In some embodiments, a step 725 of filtering the monitoring data and/or the controlling data may be applied. In some embodiments, the filtering allows selecting monitoring data and/or the controlling data that are relevant for the generation of the yield prediction and discard the monitoring data and/or the controlling data that are not relevant. At a step 730, a script is executed so as to generate alerts (at a step 740) and/or yield predictions (at a step 750). In some embodiments, the step 725 is relied upon to reduce an amount of data to be processed at step 730 thereby reducing a response time.

In some embodiments, yield prediction may rely on past data to predict an outcome of a current crop. Using plant science traits as features for a yield prediction algorithm, an extrapolation may be relied upon to generate data points associated with allotted timeframe. The data points may then be relied upon to generate volume yield prediction and/or weight yield prediction. In some embodiments, alerts may be sent to a user if yield prediction exceeds a determined range. In some embodiments, the yield predictions may be a numerical value reflective of a volume and/or a weight of a crop harvest. Other variations may also be envisioned, such as a universal algorithm applicable to multiple phenotypes of plant production. In some embodiments, the universal algorithm relies on machine-vision to classify a plant genotype and then identify a corresponding algorithm to be used for the determined classification. Once generated, the yield prediction may be stored.

In some embodiments, the method 700 also executes a step 760 of acquiring actual yields inputted by a user. The acquired actual yields may then be used to execute weight recalculation at a step 770 and then fed into a trained algorithm at a step 780. In some embodiments, the weight recalculation is executed in comparison with previous growth journals of a same phenotype, thereby improving accuracy of future yield predictions. In some embodiments, the step 730 relies on the step 780 to generate the alerts and/or the yield predictions. In some embodiments, the step 730 and/or the step 780 are executed by the machine-learning module 370. As it may be appreciated, as growth cycles of a given crop are completed, predicted yields and actual yields along with associated monitoring data and/or control data may be compared and analyzed to improve an accuracy of the machine-learning module 370.

In some embodiments, the method 700 also executes a looped pipeline process 790. In an embodiment, the looped pipeline process is continuously running in the machine learning module 370 of FIG. 4. The looped pipeline process 790 comprises a first module 792, a second module 794 and a third module 796. The first module 792 relates to the processing of features comprising an initial set of historical sensor data and a corresponding yield. A set of features may be tested in one or more of the algorithm of the second module 794. In some embodiments, the set of features may comprise, without being limitative, a basic value or a derived value from one or more conditions of the growth environment (e.g., radiation, sunrise, sunset). The outcome may then be measured against metrics in the third module 796. One evaluation may be referred to as one “cycle” of the looped pipeline process 790. In some embodiments, if the metrics are not met by the outcome of the second module 794, another set of features is generated and another “cycle” of the looped pipeline process 790 is executed. The looped pipeline process 790 executes “cycle” up until a set of features and algorithm combination satisfying the metrics is identified. The set of features and the algorithm may then be relied upon by the yield prediction module 340.

In some embodiments, the metrics may comprise a low mean absolute percentage error (MAPE), a low mean squared error (MSE), low maximum absolute percentage error (Max APE). In some embodiments, the MAPE may measure an average absolute error in the prediction over a time range of a given test data. The MAPE may measure an average error performance of an algorithm. In some embodiments, the MSE may comprise a mean of a square difference of an individual prediction from an actual yield over a given test data. The MSE may measure the deviation of an error performance of the algorithm. In some embodiments, the Max APE may comprise a maximum error in prediction over a given test data. The Max APE may measure a biggest prediction error for a same time range.

In some embodiments, the first module 792 may comprise set of features such as plant sciences features. As a first example, one or more features of the set of features may relate to light, temperature, relative humidity and/or CO2. With respect to light, plant sciences features may comprise “longer days=faster flowering; faster flowering=harvest sooner”; “Tomato On Vine (TOV)=about 7 weeks from flower to harvest”, “more than 14 hours does not improve growth”, and/or “tomatoes are day neutral plants”. With respect to temperature, plant sciences features may comprise “warm during day=26.5 Celsius” and/or “cool during night=15-20 Celsius”. With respect to relative humidity, plant sciences features may comprise “consistently set at a high level=about 75%” and/or “drop in humidity=drop in growth rate”. With respect to CO2, plant sciences features may comprise CO2 thresholds.

In some embodiments, the second module 794 may comprise algorithm such as random forest regressor, lasso, elastic net, ridge, bayesian ridge, linear regression, Automatic Relevance Determination (ARD) regression, Stochastic Gradient Descent (SGD) regressor, passive aggressive regressor, k-neighbors regressor and/or Support Vector Regression (SVR).

The prediction model therefore may contain a plurality of algorithms that may evolve over time. In an embodiment, a yield prediction algorithm may be developed using indoor climate data from a greenhouse where the crop of interest is grown, the climate data being coupled with institutional knowledge from academic publications and with “best practice” advice from experienced growers. This approach provides some interesting results. In simulations, using this limited set of data in the prediction model allowed to estimate the growth of a crop of interest with a 17% average error margin, which is a sizeable improvement over the 25% average error using conventional techniques (FIG. 24).

One of the goals of the present technology is to arrive at an optimal combination of parameters that drives a specific greenhouse's yield for the crop being considered. Another embodiment covers a more comprehensive view of the current state and environmental conditions of a crop by adding parameters that allow to accurately and consistently predict the yield of a crop week by week. The prediction model arrives at an accurate yield prediction algorithm by collecting a comprehensive set of data, allowing a separate overlaid algorithm to combine and accept the topmost essential parameters that drive the yield of a specific crop grown in a greenhouse being considered. This overlaid algorithm quantifies the likelihood that a parameter (e.g., temperature, humidity, lighting level, light spectrum) will affect and/or correlate with the yield of a crop.

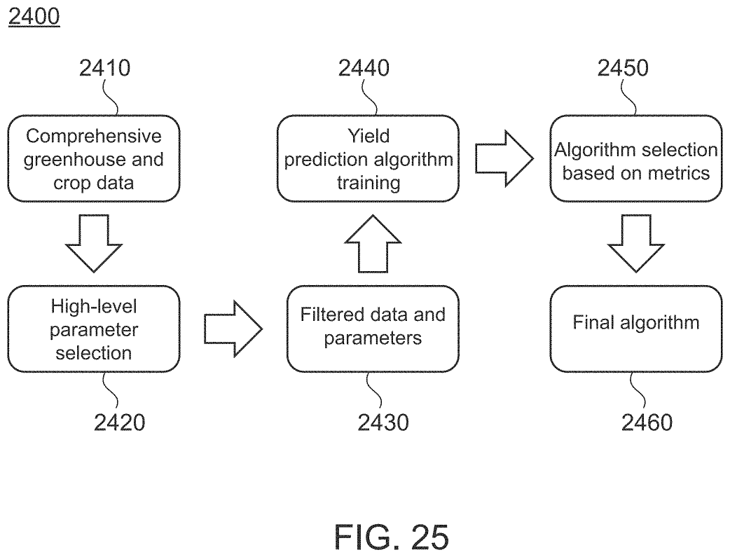

In this respect, FIG. 25 illustrates a flow of an algorithm development process in accordance with an embodiment of the present technology. In a sequence 2400, operation 2410 comprises the acquisition of comprehensive greenhouse data and crop data for a given plant phenotype. A high-level selection of parameters that best affect yield for the plant phenotype is executed at operation 2420. Data and parameters are filtered at operation 2430. The yield prediction algorithm is trained at operation 2440 using training data associated with a given growth environment profile. Multiple algorithms are selected based on metrics at operation 2450. At operation 2460, the parameters from operation 2420 are fed into the multiple algorithms selected at operation 2450. In this operation 2460, each of the multiple algorithms is back tested to output a respective error. The algorithm that produces a smallest error is elected as it represents the best algorithm for the plant phenotype. In a non-limiting example, the metrics may include (i) a mean absolute percentage error, which is the average error performance of the algorithm over a specific test time frame, (ii) a maximum error, which is the worst performance of the algorithm in a given test data, (iii) a number of significant errors, which is a frequency of significant errors (e.g. at least 15%) of an algorithm over a given test data, and (iv) a number of over and/or under projections, which is a frequency that the algorithm over-projects and under-projects harvest. Other metrics and metric combinations are also contemplated.

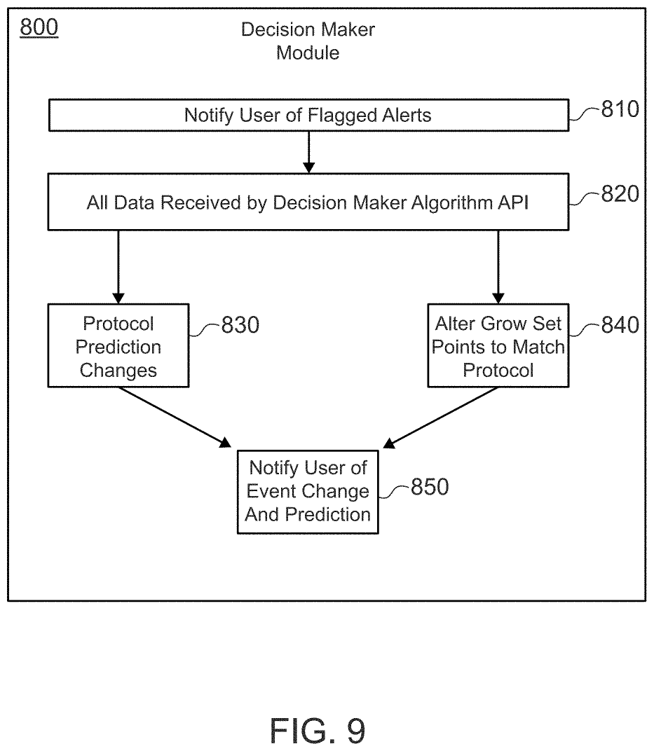

An embodiment of the decision maker module 350 is exemplified in FIG. 9. In this embodiment, the decision maker module 350 is configured to execute various steps of a method 800 allowing generating a predictive recommendation relating to the growth environment. In some embodiments, the method 800 may also allow modifying the dynamic growth protocol based on the predictive recommendation and commanding control devices 220 to implement updated control values. In some embodiments, the method 800, at a step 810, notifies the user of an alert. The alert may have been generated by the dynamic growth protocol module 330 and/or the yield prediction module 340. At a step 820, the data generated and/or acquired by the dynamic growth protocol module 330 and/or the yield prediction module 340 may be transmitted to a decision maker algorithm API. The decision maker algorithm API may be hosted by the system 300 or may be hosted by a dedicated service platform accessible by the system 300. In some embodiments, the data transmitted to the decision maker algorithm API may comprise monitoring data and/or control data and/or calculated growth index and/or yield predictions. In some embodiments, the data transmitted to the decision maker algorithm API may also comprise external data not directly related to the growth environment. Such external data may comprise weather data that may be obtained from a dedicated service platform to which the system 300 has access. In some embodiments, the data may be filtered prior to generating a predictive recommendation.

In some embodiments, using past data from a dynamic growth phenotype, simulations may be run on different scenarios. The calculated simulations may allow identification of scenarios that may increase yield, reduce electricity consumption and/or reduce an amount of human intervention. In some embodiments, one or more scenarios providing a highest yield potential may be used as a guideline to automatically adapt the dynamic growth protocol. As an example, but without being limitative, humidity may be detected as rising after lights are turned to “OFF”. Simulation may allow determining that humidity has to be dropped using the de-humidifier before the lights are turned to “OFF”. The simulation may, in this example, assess yield, electricity consumption (more efficiency at certain temperature and/or humidity level) and/or an amount of human intervention. Results generated by the simulation may be transmitted to the decision maker module 350.

In some embodiments, the predictive recommendation may be generated by the machine-learning module 370.

Once the predictive recommendation is generated, the method 800 may proceed to a step 830 and/or a step 840. The step 830 comprises modifying predictions associated with the dynamic growth protocol. This action may be undertaken through the dynamic growth protocol module 320. The step 840 comprises altering growth set points to match the dynamic growth protocol. In some embodiments, alert set points and/or trigger set points may be automatically adjusted to match the dynamic growth protocol currently being used. This may allow plants to follow a same growth index curve than the growth index curve of previous growths. This may also serve as a reference point for future growths. This action may result in modifying the dynamic growth protocol that is being executed. Modifying the dynamic growth protocol may comprise updating control data associated with the dynamic growth protocol based on the predictive recommendation. In an example, but without being limitative, when a humidifier trigger set point range is set at 30-50% and in previous dynamic growth protocols a change to 40-60% is identified on day 23, a current humidifier trigger set point may be adjusted at that specific date (i.e., day 23). The method 800 may then, at a step 850, notify the user of event change and yield prediction.

In some embodiments, the decision maker module 350 may notify the user of alerts generated by the dynamic growth protocol module 320, the growth index module 330 and/or the yield prediction module 340. In some embodiments, the decision maker module 350 may notify the user by sending an email, an SMS or a notification from an application associated with the system 300.

In some embodiments, the decision maker module 350 may command the control devices 220 to implement updated control values that may be generated based on the updated control data. For example, the decision maker module 350 may automatically cause the control devices 220 to modify one or more environmental factors of the growth environment. For example, but without being limitative, an HVAC unit, light sources and/or humidifiers may change their respective settings to implement the predictive recommendation. In some embodiments, the predictive recommendation may comprise reproducing events of past dynamic growth protocols stored in the dynamic growth protocol database 372.

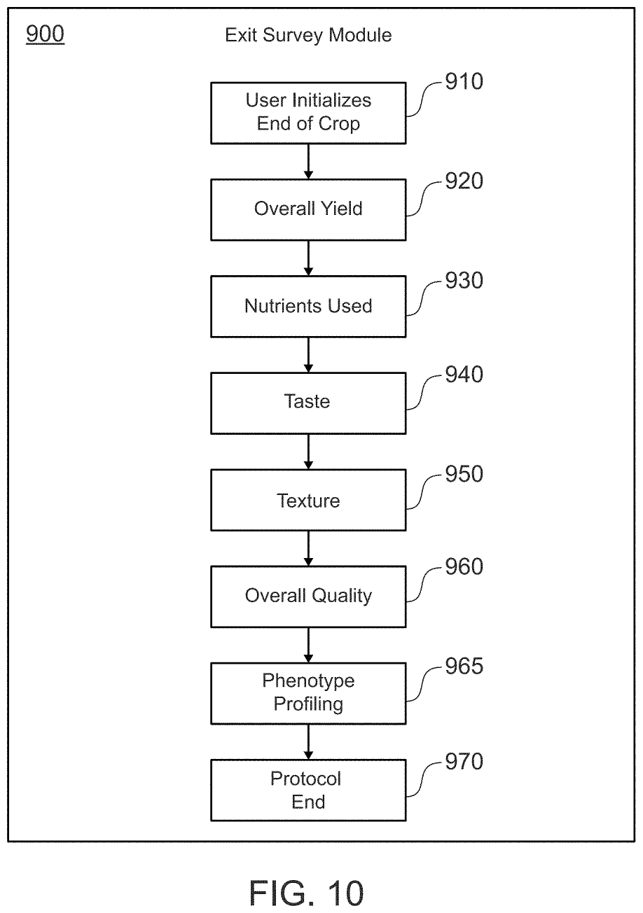

An embodiment of the exit survey module 360 is exemplified in FIG. 10. In this embodiment, the exit survey module 360 is configured to execute various steps of a method 900 allowing collecting data that may then be used by the system 300 to compare actual yield results with predictive yields and/or store the actual yield results for future use by the system 300. Upon ending a growth cycle of a crop, the system 300 and/or the user may cause to execute a step 910 to initiate the exit survey module 900. In some embodiments, the step 910 generates a time stamp associated with the end of the growth cycle of the crop. At a step 920, the method 900 may proceed with acquiring an overall yield result. At a step 930, the method 900 may proceed with acquiring a value reflective of an amount of used nutrients. At a step 940, the method 900 may proceed with acquiring data relating to a taste associated with the crop. Some examples of taste criteria are, but not limited to, flavor, aroma or sweetness. At a step 950, the method 900 may proceed with acquiring data relating to a texture associated with the crop. Some examples of texture criteria are, but not limited to, softness, color, or firmness. At a step 960, the method 900 may proceed with acquiring data relating to an overall quality associated with the crop. In some embodiment, using the data supplied in method 900, plant phenotype is recorded into the plant phenotype DB 376, at step 965. Data stored in the plant phenotype DB 376 can be utilized within the machine learning system 370. The method 900 ends at a step 970 when the dynamic growth protocol ends, signifying the completion of the growth cycle. The acquired data is stored in the dynamic growth protocol module 320. In some embodiments, the acquired data may be used to generate a general assessment of a performance of the dynamic growth protocol applied during the growth cycle.

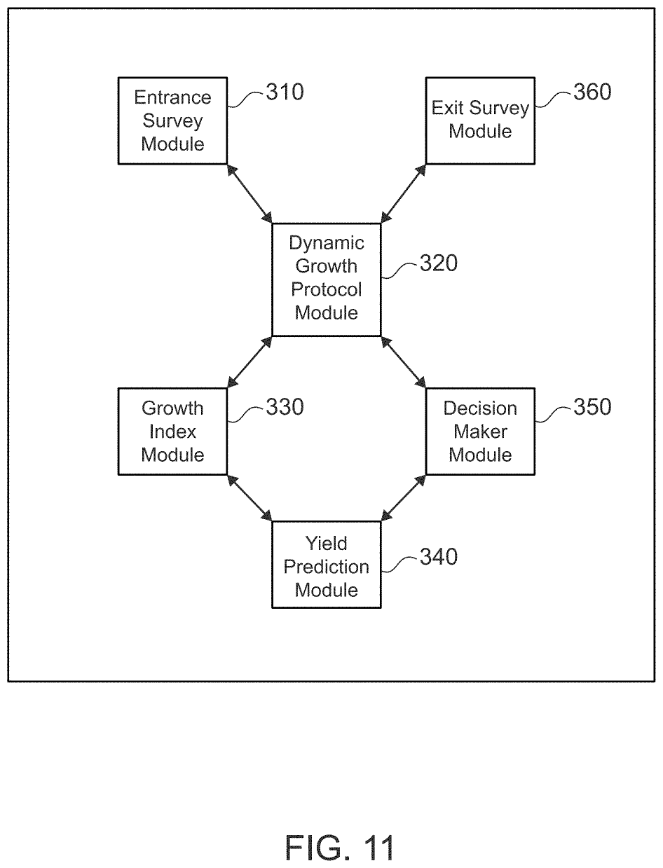

Turning now to FIG. 11, an exemplary embodiment of how the entrance survey module 310, the dynamic growth protocol module 320, the growth index module 330, the yield prediction module 340, the decision maker module 350 and the exit survey module 360 may interact together. In some embodiments, modules 320-360 may enable repetition of dynamic growth protocols throughout multiple growth cycles with high probability of achieving constant results. This may be achieved by causing the control devices 220 located within the growth environment to reproduce similar environmental factors at every step of the growth cycle. In some embodiments, modules 320-360 may automatically adjust an execution of a dynamic growth protocol to automatically correct deviation from a given dynamic growth protocol. In some embodiments, the modules 320-360 may enable an automated execution of a complete growth cycle of a crop (also referred to as “1-click grow”) without requiring any manual intervention from a user.

In some embodiments, modules 310-360 may allow controlling the environmental factors influencing the growth of a crop within a growth environment. In some embodiments, the entrance survey module 310 may acquire data relating to the growth environment and/or the crop for which a growth cycle is to be executed. In some embodiments, the dynamic growth protocol module 320 may identify and access a set of control data modeling a dynamic growth protocol for the crop. The dynamic growth protocol module 320 may then command one or more control devices 220 installed within the growth environment to implement control values. The control values may be the control data. In some embodiments, the control values may be derived based on the control data. Implementation of the control values by the one or more control devices 220 results in a generation and/or control of one or more environmental factors within the growth environment. The dynamic growth protocol module 320 may also receive monitoring data generated by one or more monitoring devices 230 (e.g., sensors). The monitoring data may inform the dynamic growth protocol module 320 of multiple values assessing one or more environmental factors. The growth index module 330 may access a multimedia file such as, but not limited to, captured images and/or videos. Alternatively, the growth index module 300 may access a data file including manual measurements of a physiological characteristic of the crop. The growth index module 330 may calculate a growth index quantifying the physiological characteristic of the crop. The yield prediction module 340 may generate one or more yield predictions. In more details, the plant phenotype DB 376 of FIG. 4 creates algorithm instances that are back-tested to give an error rate, for example a mean absolute percentage error (MAPE), that determines the confidence level of each algorithm instance. Each algorithm instance is recorded in the training module DB 384 with its error rate in preparation for algorithm retrieval at step 720. The decision maker module 350 may then use the monitoring data, the growth index and/or the one or more yield predictions to generate one or more predictive recommendations. The decision maker module 350 may then communicate with the dynamic growth protocol module 320 so that the dynamic growth protocol may update the set of control data based on the one or more predictive recommendations. The dynamic growth protocol module 320 may command the control device 220 to implement updated control values generated based on the updated set of control data. The dynamic growth protocol module 320 may therefore cause adjustment of the one or more environmental factors. In some embodiments, the exit survey module 360 may acquire data relating at the end of the growth cycle. The acquired data may then be stored and/or analysed to improve the prediction model to improve accuracy and performance of future growth cycles.

Turning now to FIG. 12-17, exemplary embodiments of how a growth index may be calculated are illustrated. In some embodiments, the growth index comprises a size of a crop, a variation of a size of a crop and/or a color index.

FIG. 12 illustrates a set of color planes 1102, 1104, 1106, 1108, 1110 and 1112 forming a color cube. Each color plane 1102, 1104, 1106, 1108, 1110 and 1112 represents a 2D color space wherein the value of Green (G) is constant while Red (R) and Blue (B) are variable. For instance, in the color plane 1102, the value G is at 100% in all areas while the values of R and B vary between 100% in the top left corner to 0% in the bottom right corner. In the color plane 1112, the value of G is at 0% in all areas while the values of R and B vary between 100% in the top left corner to 0% in the bottom right corner. Although shown in various shades of grey in the present disclosure, the color planes of FIG. 12 are meant to represent actual colors.

In some embodiments, the growth index is generated based on a subset of the color cube, the subset including a pre-defined number of color planes among the above described set of color planes. The subset is defined by plant-color regions of a visible light spectrum. In a non-limiting embodiment, the pre-defined number of color planes in the subset is five. Color planes 1122, 1124, 1126, 1128 and 1130 illustrate examples of color planes defined by plant-color regions of the visible light spectrum. In some embodiments, the color planes forming this subset encompass colors that may be found in real-life plants. Each color plane comprises a set of row of colors, also referred to as color arrays. A color array is defined by a constant value of G, a constant value of R and a variable B. The growth index is generated based on six color arrays for each color plane. In the non-limiting embodiment of FIG. 12, the growth index is generated based on 30 color arrays (six color arrays 1132, 1134, 1136, 1138, 1140 and 1142, distributed over the five color planes 1122, 1124, 1126, 1128 and 1130).

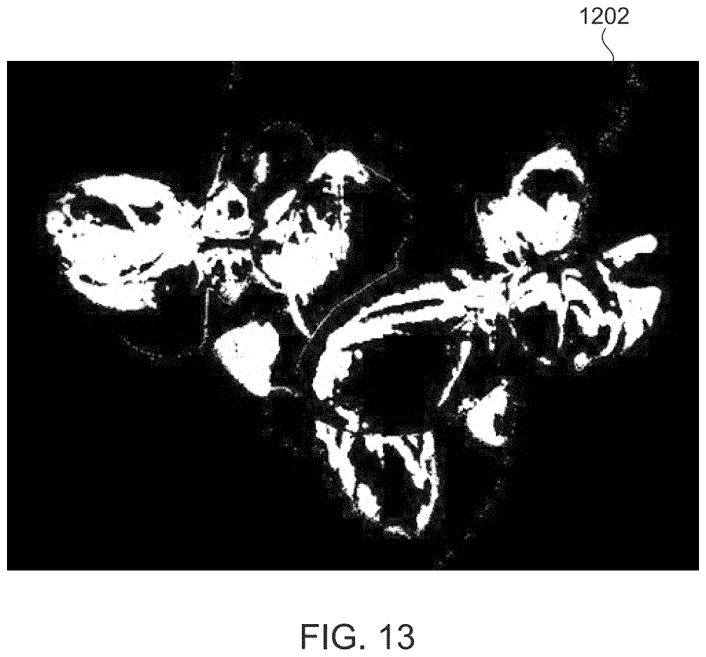

FIG. 13 illustrates a first representation 1202 of colors of a real-life crop that belongs to color array 1138 of color plane 1124, at area 1144 of an exemplary defined color space (e.g., a set of color planes). In some embodiments, the growth index is generated by iterating over the color planes and/or color arrays. Any pixel from a representation that does not belong to a currently evaluated color plane and/or color arrays is masked out (i.e., overlaid with a black pixel).

In some embodiments, a size of a crop is quantified by counting a change (e.g., an increase or a decrease) in green pixels over time. If a crop is growing, a number of pixels in a second captured image (which is taken at time >0) that belong to a green color arrays is expected be higher compared to that of a first captured image (which is taken at time=0). In some embodiments, quantifying the size of the crop may be less concerned with nuances or quality of the greens in the crop. In some embodiments, quantifying the size of the crop is based on a quantity of pixels identified as green pixels; for instance an increase in red pixels may be expected when growing red bell peppers. In some embodiments, pixels may be stored in a 3D array wherein an innermost array contains G-B-R values. In some embodiments, quantifying the size of the crop is based on a quantity of pixels identified as green pixels and yellow pixels (i.e., as part of a “green” color space). In some embodiments, brown pixels and red pixels may be ignored (i.e., the brown pixels and the red pixels may not be count in quantifying the size of the crop). In some embodiments, to avoid pixel-to-pixel (i.e., array-to-array) color (value) evaluation, conversion of a captured image to black and white is generated. As an example, but without being limitative, in some embodiments, an open source computer vision (OpenCV) function is evoked to count “non-zero” pixels.

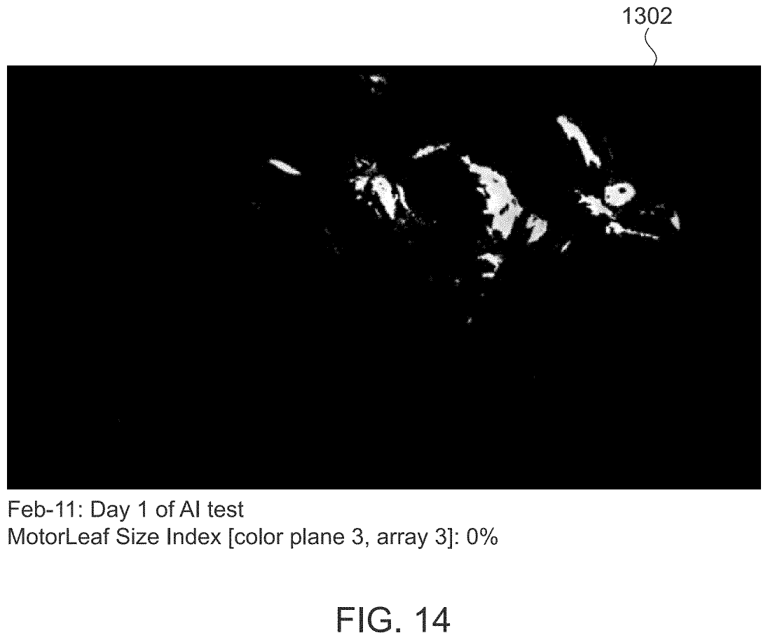

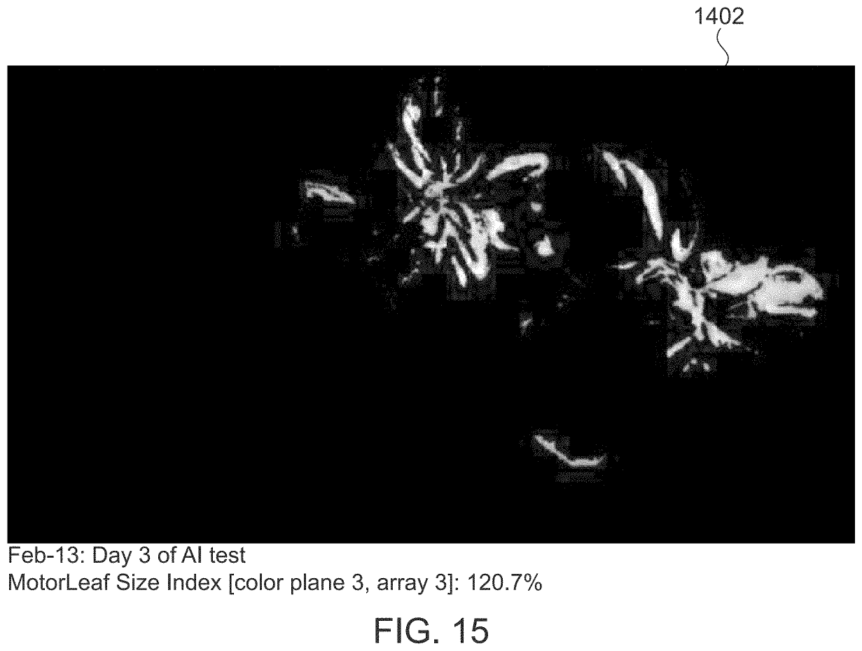

FIG. 14 illustrates a first representation 1302 of a crop. The first representation 1302 illustrates a crop wherein green pixels are selected according to color plane 1126 (out of 5 color planes) and color array 1136 (out of 6 color arrays). The first representation 1302 is dated Day 1. At Day 0, control devices 220 have modified parameters so that the crop is subjected to a pH=6.5 and nutrients A and B were added (10 ml each on a 12-liter reservoir). At Day 1, the variation of the size of the crop is 0%. The same crop is illustrated at FIG. 15 in a second representation 1402 of the crop of FIG. 14. The second representation 1402 is dated Day 3. At Day 3, the variation of the size of the crop is 120.7%.

In some embodiments, the growth index may comprise a color index comprising a set of values representing normalized sums of green pixels (or of pixels of another selected color) in a color array group. In some embodiments, the set of values is a set of six values and the color array groups comprise six color array groups. In some embodiments, a color array group comprises color arrays with a same index from the set of color planes. For example, a first color array group may comprise all the first color arrays from all the color planes, a second color array group may comprise all the second color arrays, and so on. In some embodiments, color arrays with a lower index (i.e., bottom end of a given color plane) may represent darker colors while color arrays with a higher index (i.e., top end of the given color plane) may represent brighter colors and/or paler colors.

In some embodiments, a color index of a highest number in a set represents a color array with the most number of green pixels. As an example, a captured image of a plant with color indexes [0.1, 0.08, 0.7, 0.01, 0.11, 0.0] may mean that the plant has most of its green pixels in the third color arrays which may be halfway between the dark regions (first of six color arrays) and palest regions (sixth of six color arrays). This may mean that a majority of pixels in the plant is neither dark green nor pale green. On the other hand, a photo of a plant with color indexes [0.9, 0.08, 0.01, 0.01, 0.0, 0.0] means that most of the pixels are of dark green shade, the highest value 0.9 represents a normalized sum of green pixels from the first of the six color arrays of the color planes.

In some embodiments, the growth index comprises a size index and a color index indicative of how well the crop is absorbing nutrients and/or growing.

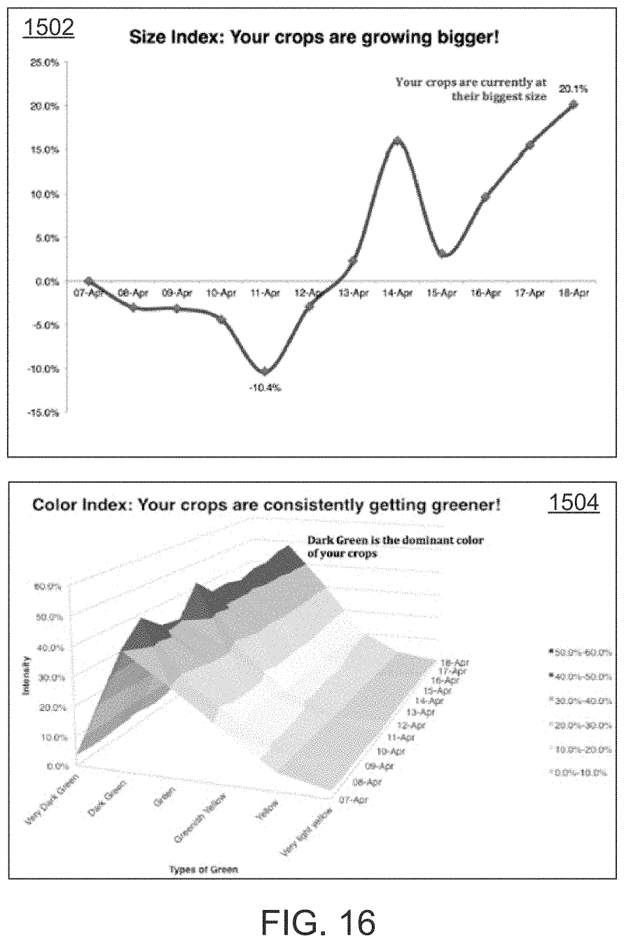

Turning to FIG. 16, a first graphical representation 1502 of values of a size index over time is illustrated. A second graphical representation 1504 is also illustrated. Intensity of shades of green overtime is represented. In the representation 1504, a horizontal axis represents groups of colors from dark green (left most) to yellow-brown (right most).

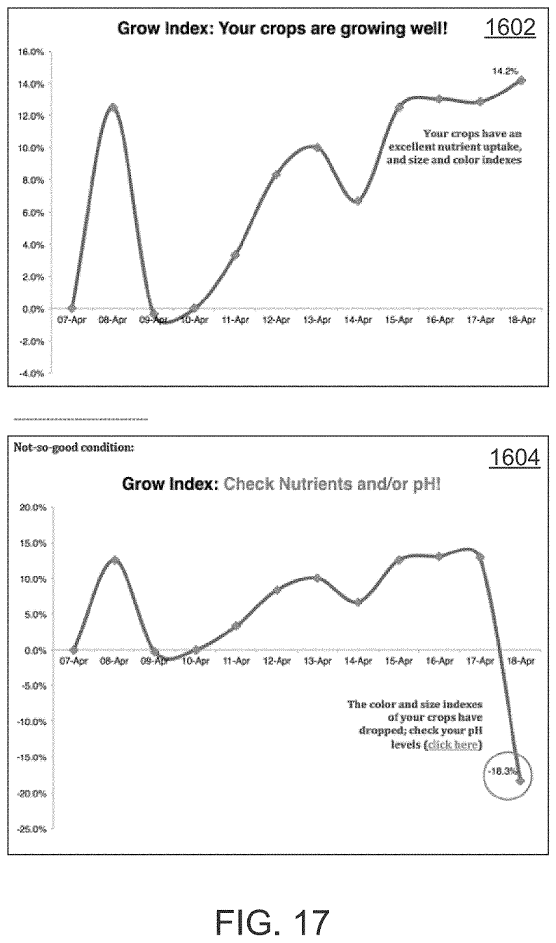

FIG. 17 illustrates an embodiment, wherein a correlation between size index, nutrient uptake and pH level is made. The first representation 1602 illustrates “good conditions” while the second representation 1604 illustrates “not so good conditions” that require attention to adjust pH levels.

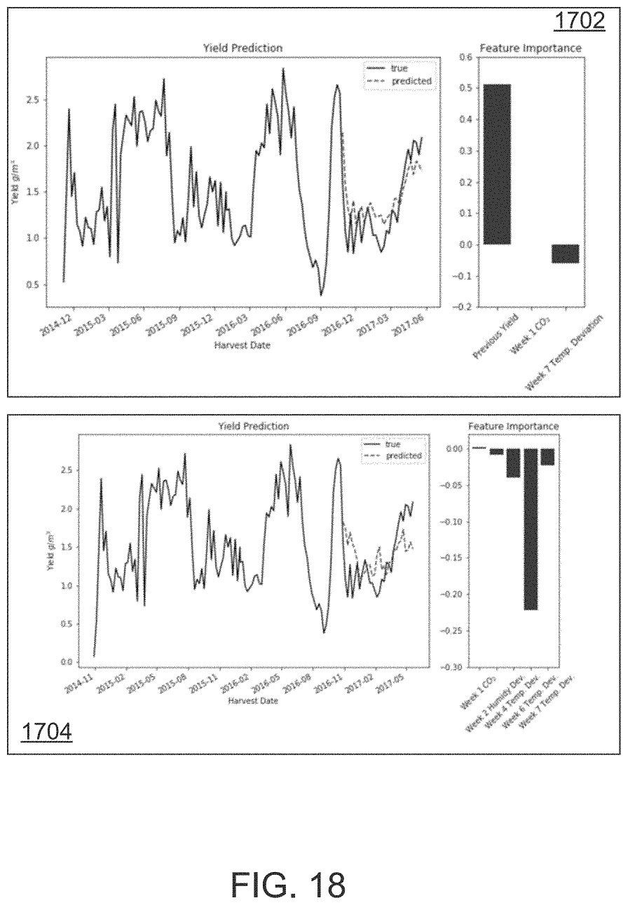

Turning now to FIG. 18, examples of generated yield predictions 1702 and 1704 are represented. The generated yield predictions 1702 also illustrates feature importance in predicting a next yield. In the illustrated example, important features include the previous yield and how close the temperature was to an ideal temperature during the next week. The level of CO2 early in the growth cycle was found as a small contributor in many experiments. The generated yield predictions 1704 also illustrates feature importance in predicting a next yield. In the illustrated example, the previous yield was excluded. Generally, higher CO2 levels increase yield, variations in humidity will decrease yield, deviations from an ideal temperature of 26.5 Celsius during daytime and 15-20 Celsius during nighttime will decrease the yield. Temperature variations toward the end of the growth cycle have a stronger impact.

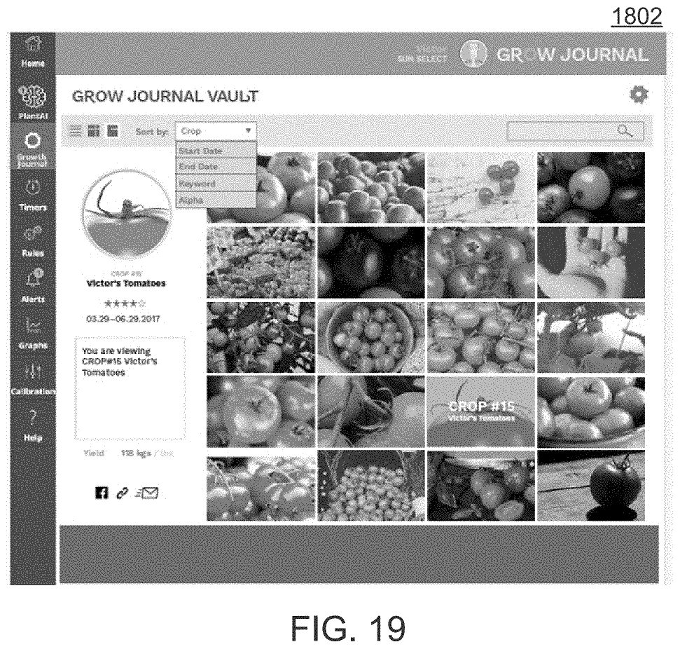

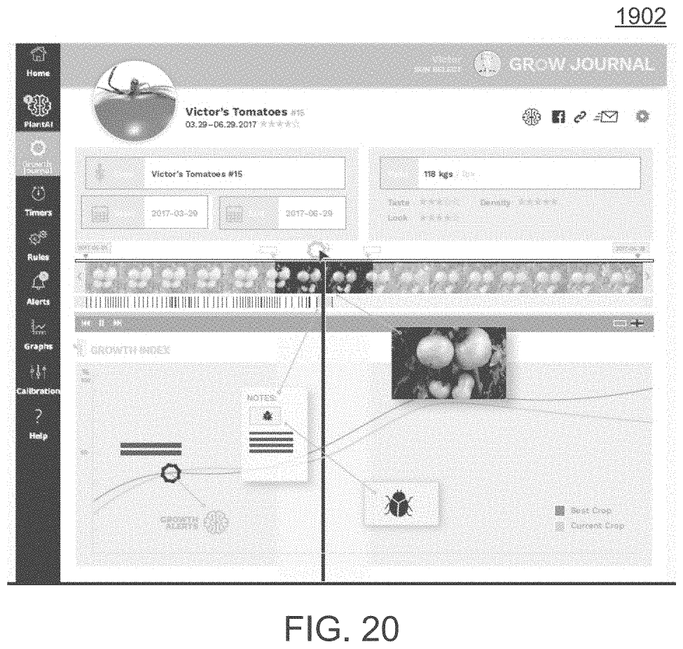

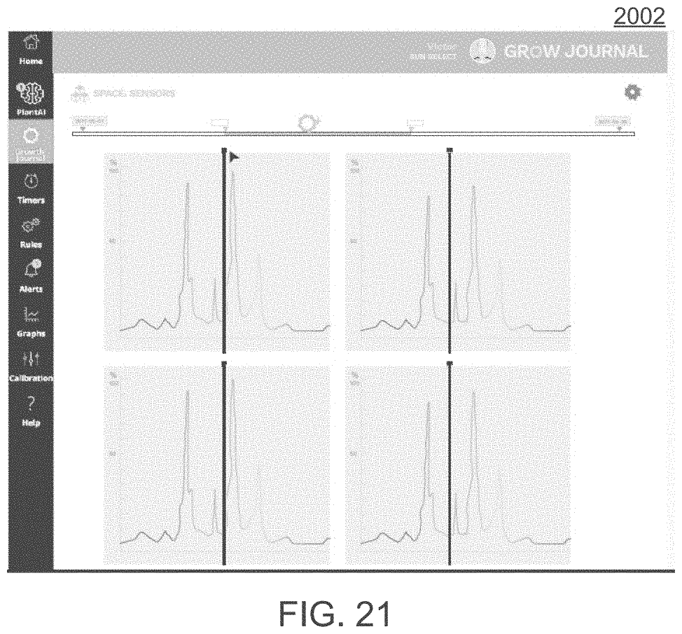

Turning now to FIG. 19-21, embodiments 1802, 1902 and 2002 of a growth journal are represented.

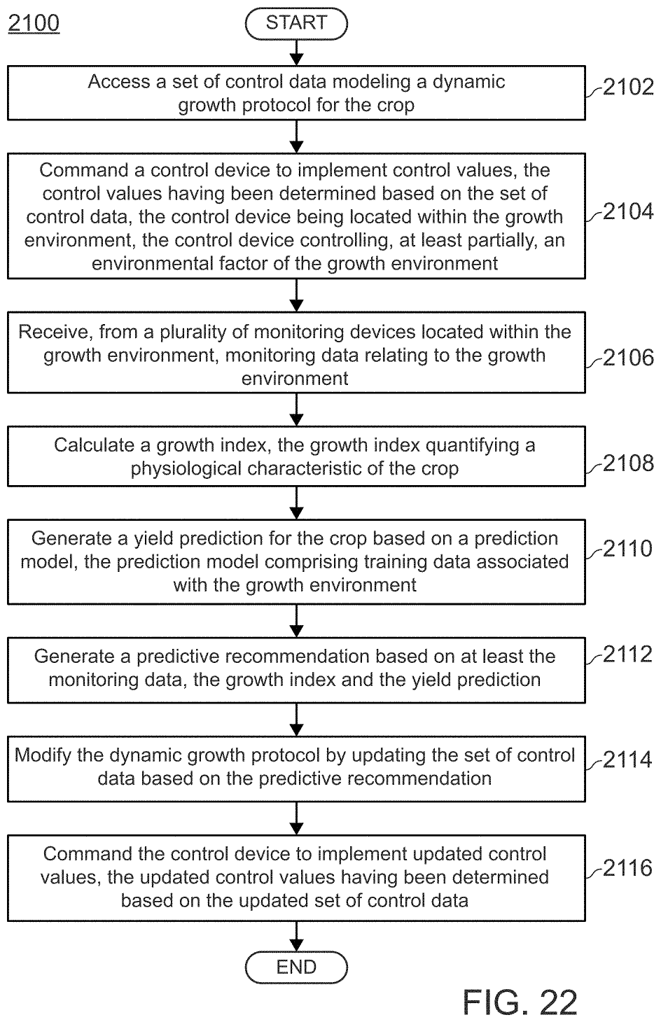

Turning now to FIG. 22, a flowchart illustrating a computer-implemented method 2100 of controlling a growth environment of a crop is illustrated. In some embodiments, the computer-implemented method 2100 may be (completely or partially) implemented on a computing environment similar to the computing environment 100, such as, but not limited to, the system 300.

The method 2100 starts at a step 2102 by accessing a set of control data modeling a dynamic growth protocol for the crop. Then, at a step 2104, the method 2100 proceeds with commanding a control device 220 to implement control values, the control values having been determined based on the set of control data, the control device 220 being located within the growth environment, the control device 220 controlling, at least partially, an environmental factor of the growth environment.

Then, at a step 2106, the method 2100 proceeds with receiving, from a plurality of monitoring devices 230 located within the growth environment, monitoring data relating to the growth environment. Then, at a step 2108, the method 2100 proceeds with calculating a growth index based on a multimedia file comprising at least one visual representation of the crop or based on a file of manual measurements of a physiological characteristic of the crop, the growth index quantifying the physiological characteristic of the crop. In some embodiments, the growth index comprises a size index of the crop and a color index of the crop. In some embodiments, the size index is generated based on a pre-defined number of color planes defined by plant-color regions of a visible light spectrum. In some embodiments, the size index is generated based on a variation in pixels that are part of a green color space (or other selected color space) over a period of time. Then, at a step 2110, the method 2100 proceeds with generating a yield prediction for the crop based on a prediction model, the prediction model comprising training data associated with the growth environment. In some embodiments, generating the yield prediction comprises executing the looped pipeline process 790, the looped pipeline process 790 iterating until a set of features and algorithm combination satisfying metrics is identified

Then, at a step 2112, the method 2100 proceeds with generating a predictive recommendation based on at least the monitoring data, the growth index and the yield prediction. In some embodiments, generating the predictive recommendation comprises correlating the growth index and the monitoring data. In some embodiments, generating the predictive recommendation comprises running simulations on different growth scenarios based on part data associated with a dynamic growth phenotype. In some embodiments, the simulations allow identification of a scenario that is associated with one of an increased yield, reduced electricity consumption and reduced an amount of human intervention. In some embodiments, generating the predictive recommendation is further based on at least one of the monitoring data and external data non-related to the growth environment.

Then, at a step 2114, the method 2100 proceeds with modifying the dynamic growth protocol by updating the set of control data based on the predictive recommendation. Then, at a step 2116, the method 2100 proceeds with commanding the control device 220 to implement updated control values, the updated control values having been determined based on the updated set of control data.

Information obtained in the execution of the method 2100 in a given growth environment allows defining a growth environment profile that may be useful in planning and controlling the growth of a crop in other similar growth environments. For example, data collected in in a first greenhouse having a certain set of characteristics (size, geographical location, equipment used for lighting, irrigation, humidity control, heating and cooling, aeroponics, hydroponics, types of fertilizers, and the like) for a certain crop type (e.g. tomatoes, lettuce, cucumbers) may be used to characterize a second greenhouse that shares several of the same characteristics. The machine-learning module 370 may reuse several growth environment profiles obtained from various sources to calculate corresponding yield predictions and select the one growth environment profile associated with the yield prediction that best matches a growth index.

In a non-limiting example, data may be collected for a first period in a greenhouse, for example over four (4) months, and a growth index for a crop, for example tomatoes, may be obtained from multimedia files or from files of manual measurements of a physiological characteristic of the crop. A plurality of growth environment profiles is used to generate corresponding yield predictions. One of the growth environment profiles associated with a yield prediction that best matches the actual growth index is selected for future use in the greenhouse. The selected growth environment profile may be updated in time by continuous learning. To this end, commands are issued to one or more control devices 220 in the greenhouse, the commands reflecting control values defined at least in part in view of the yield prediction associated with the selected growth environment profile. A multimedia file obtained at a later date or a file containing manual measurements obtained at a later date, for example two (2) months later, is then use to calculate a later growth index. The growth environment profile is updated based on the later growth index, which should match at least to a certain extent the yield prediction.

Data may be received from other controller units similar to the controller unit 210. In this way, a network of cooperating controller units may exchange information from their respective dynamic growth protocol DBs and their respective training model DBs.

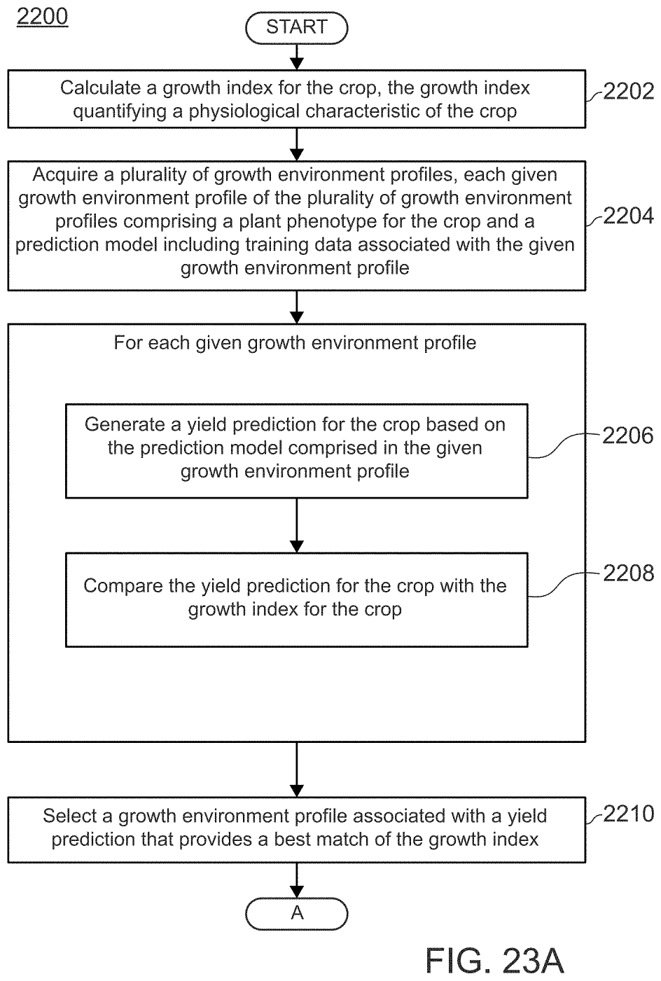

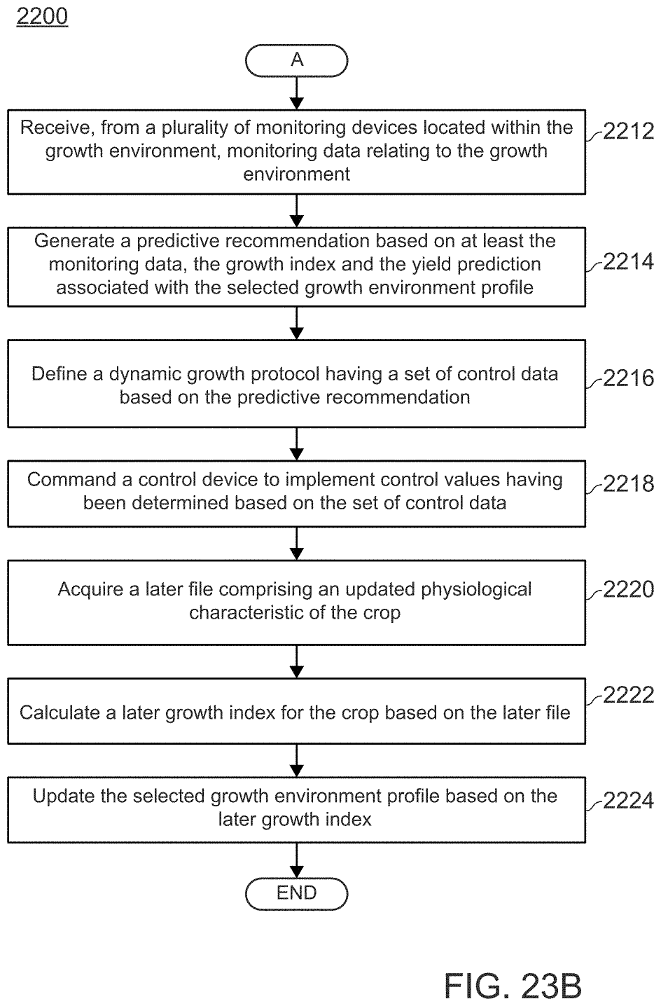

Turning now to FIGS. 23A and 23B, a flowchart illustrating a computer-implemented method 2200 of selecting a profile for a growth environment of a crop is illustrated. In some embodiments, the computer-implemented method 2200 may be (completely or partially) implemented on a computing environment similar to the computing environment 100, such as, but not limited to, the system 300.

As shown on FIG. 23A, the method 2200 starts at a step 2202 by calculating a growth index for the crop. The growth index quantifies a physiological characteristic of the crop. The growth index for the crop may be calculated based on a multimedia file comprising at least one visual representation of the crop or based on manual measurements of the physiological characteristic of the crop. The physiological characteristic of the crop quantified in the growth index may include one or more of fruit weight, leaf size, stem diameter, number of flower clusters, and number of flowers in clusters. Several growth environment profiles are acquired at step 2204. Each given growth environment profile of the plurality of growth environment profiles comprises a plant phenotype for the crop and a prediction model that includes training data associated with the given growth environment profile.

Operations 2206 and 2208 are performed for each given growth environment profile. In more details, operation 2206 comprises generating a yield prediction for the crop based on the prediction model comprised in the given growth environment profile. The yield prediction for the crop is compared with the growth index for the crop at operation 2208. When operations 2206 and 2208 have been performed for each given growth environment, a growth environment profile associated with a yield prediction that provides a best match of the growth index is selected at operation 2210.

Continuing now on FIG. 23B, monitoring data relating to the growth environment may be received, at operation 2212, from a plurality of monitoring devices 230 located within the growth environment. A predictive recommendation may be generated at operation 2214 based on at least the monitoring data, the growth index and the yield prediction associated with the selected growth environment profile. Then, a dynamic growth protocol may be defined at operation 2216, the dynamic growth protocol having a set of control data based on the predictive recommendation. The set of control data may be used as a base to determine control values used to command a control device 220 at operation 2218.

Some time later, when the crop has matured at least to some extent, operation 2220 comprises acquiring a later file comprising an updated physiological characteristic of the crop. The later file may be a later multimedia file comprising at least one later visual representation of the crop or a later file of manual measurements. A later growth index for the crop is calculated at operation 2222 based on the later file. At operation 2224, the growth environment profile selected at operation 2210 is updated based on the later growth index.

While the above-described implementations have been described and shown with reference to particular steps performed in a particular order, it will be understood that these steps may be combined, sub-divided, or re-ordered without departing from the teachings of the present technology. At least some of the steps may be executed in parallel or in series. Accordingly, the order and grouping of the steps is not a limitation of the present technology.

It should be expressly understood that not all technical effects mentioned herein need to be enjoyed in each and every embodiment of the present technology.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

What is claimed is:

1. A computer-implemented method for generating a yield prediction algorithm to be associated with a controlled growth environment, the method comprising:
accessing a first set of data associated with the controlled growth environment, the first set of data comprising sensor data and corresponding actual yield values, the sensor data being associated with a plurality of environment parameters;
accessing a database comprising a plurality of features modeling an impact of the plurality of environment parameters and corresponding values of the environment parameters on a growth of a crop;
accessing a plurality of machine learning algorithms (MLAs), the plurality of MLAs having been trained to predict a value of a yield based on at least some of the plurality of environment parameters;
(i) selecting one or more environment parameters amongst the plurality of environment parameters of the database;
(ii) selecting one MLA amongst the plurality of MLAs;
(iii) testing the selected one or more environment parameters on the selected MLA, the testing comprising:
inputting, to the selected MLA, data from the first set of data corresponding to the selected one or more environment parameters;
generating a metric associated with a yield value prediction outputted by the selected MLA, the metric being based on the outputted yield value prediction and the actual yield value corresponding to the data;
selecting a combination of one or more environment parameters and MLA based on metrics generated after a plurality of iterations of (i) to (iii); and
returning the selected combination of one or more environment parameters and MLA.

2. The method of claim 1, wherein the controlled growth environment is a greenhouse.

3. The method of claim 1, wherein the first set of data comprises at least of temperature data, atmospheric data, visual data or soil data.

4. The method of claim 1, wherein the first set of data is generated by a monitoring device, the monitoring device being at least one of an air temperature thermometer, a soil temperature thermometer, a liquid temperature thermometer, an Infra-Red (IR) thermometer, an Ultra-Violet (UV) sensor, a Photosynthetically Active Radiation (PAR) level sensor, an Electrical Conductivity (EC) sensor, a Total Dissolved Solid (TDS) sensor, an Oxygen sensor, an atmospheric humidity sensor, a soil moisture sensor, a CO2 sensor, a gas composition sensor, a light level sensor, a color sensor, a pH sensor or a liquid level sensor.

5. The method of claim 1, wherein the features comprise plant sciences features relating to at least one of light, temperature, relative humidity or carbon dioxide.

6. The method of claim 1, wherein the database comprises data accessed from remote resources, the remote sources being at least one of a source of open source data models, a source of climate data or a source of research data.

7. The method of claim 1, wherein the plurality of MLAs comprises algorithms implementing at least one of random forest regressor, lasso, elastic net, ridge, bayesian ridge, linear regression, Automatic Relevance Determination (ARD) regression, Stochastic Gradient Descent (SGD) regressor, passive aggressive regressor, k-neighbors regressor and/or Support Vector Regression (SVR).

8. The method of claim 1, wherein selecting the one or more environment parameters amongst the plurality of environment parameters comprises at least one of (i) selecting the one or more environment parameters amongst the plurality of environment parameters based on the features modeling the impact of the plurality of environment parameters or (ii) executing a high-level selection of parameters that best affect a yield for a given plant phenotype.

9. The method of claim 1, wherein selecting one MLA amongst the plurality of MLAs comprises selecting based on metrics.

10. The method of claim 1, wherein selecting a combination of one or more environment parameters and MLA is executed by an overlaid algorithm.

11. The method of claim 1, wherein the one or more environment parameters comprise at least one of a basic value or a derived value from a condition of the controlled growth environment.

12. The method of claim 1, wherein the yield value is a numerical value reflective of a volume or weight of a crop harvest.

13. The method of claim 1, wherein the metric comprises at least one of a low mean absolute percentage error (MAPE), a low mean squared error (MSE) or a low maximum absolute percentage error (Max APE).

14. The method of claim 1, wherein the generated yield prediction algorithm is executed as part of controlling the controlled growth environment.

15. A computer-implemented method for generating a prediction algorithm to be associated with a controlled growth environment, the method comprising:
accessing a first set of data associated with the controlled growth environment;
accessing a database comprising a plurality of features modeling an impact of the plurality of environment parameters and corresponding values of the environment parameters on a growth of a crop;
accessing a plurality of machine learning algorithms (MLAs), the plurality of MLAs having been trained to predict a crop performance based on at least some of the plurality of environment parameters;
selecting a combination of one or more environment parameters and MLA based on metrics generated after a plurality of iterations of testing selected environment parameters and selected MLAs; and
returning the selected combination of one or more environment parameters and MLA.

16. The method of claim 15, wherein the first set of data comprises sensor data and corresponding actual yield values, the sensor data being associated with a plurality of environment parameters.

17. The method of claim 15, wherein selecting the combination of one or more environment parameters and MLA based on metrics comprises:
(i) selecting one or more environment parameters amongst the plurality of environment parameters of the database;
(ii) selecting one MLA amongst the plurality of MLAs;
(iii) testing the selected one or more environment parameters on the selected MLA; and
selecting a combination of one or more environment parameters and MLA based on metrics generated after a plurality of iterations of (i) to (iii).

18. The method of claim 17, wherein testing the selected one or more environment parameters on the selected MLA comprises:
inputting, to the selected MLA, data from the first set of data corresponding to the selected one or more environment parameters; and
generating a metric associated with a yield value prediction outputted by the selected MLA, the metric being based on the outputted yield value prediction and an actual yield value corresponding to the data.

19. The method of claim 15, wherein the generated prediction algorithm is executed as part of controlling the controlled growth environment.

20. A computer implemented system, the system comprising:
a processor;
a non-transitory computer-readable medium, the non-transitory computer-readable medium comprising control logic which, upon execution by the processor, causes:
accessing a first set of data associated with a controlled growth environment, the first set of data comprising sensor data and corresponding actual yield values, the sensor data being associated with a plurality of environment parameters;
accessing a database comprising a plurality of features modeling an impact of the plurality of environment parameters and corresponding values of the environment parameters on a growth of a crop;
accessing a plurality of machine learning algorithms (MLAs), the plurality of MLAs having been trained to predict a value of a yield based on at least some of the plurality of environment parameters;
(i) selecting one or more environment parameters amongst the plurality of environment parameters of the database;
(ii) selecting one MLA amongst the plurality of MLAs;
(iii) testing the selected one or more environment parameters on the selected MLA, the testing comprising:
inputting, to the selected MLA, data from the first set of data corresponding to the selected one or more environment parameters;
generating a metric associated with a yield value prediction outputted by the selected MLA, the metric being based on the outputted yield value prediction and the actual yield value corresponding to the data;
selecting a combination of one or more environment parameters and MLA based on metrics generated after a plurality of iterations of (i) to (iii); and
returning the selected combination of one or more environment parameters and MLA.
